(19) United States
(12) Patent Application Publication
(10) Pub. No.: US 2011/0035104 A1
(43) Pub. Date: Feb. 10, 2011

(54) SUSPENSION CONVERSION METHOD AND APPARATUS

(76) Inventor: Judson Smith, Greencastle, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/761,338

(22) Filed: Apr. 15, 2010

Related U.S. Application Data
(60) Provisional application No. 61/169,648, filed on Apr. 15, 2009.
(60) Provisional application No. 61/180,212, filed on May 21, 2009.
(60) Provisional application No. 61/224,293, filed on Jul. 9, 2009.
(60) Provisional application No. 61/238,155, filed on Aug. 29, 2009.
(60) Provisional application No. 61/239,314, filed on Sep. 2, 2009.

(51) Int. Cl. B60G 17/017; B60G 11/26; B23P 17/00

(52) U.S. Cl. 701/37; 280/124.157; 280/6.151; 29/401.1

(57) ABSTRACT

Methods and apparatus for modifying a vehicle chassis. In one embodiment the modified vehicle is capable of being placed close to the roadway at a position suitable for deployment of a wheel chair ramp that complies with ADA requirements. In yet another embodiment, the vehicle can be raised to a position in which the frame of the vehicle is higher than it was when the ramp was deployed, such that the frame provides crash worthiness to the vehicle relative to side impacts. Yet other embodiments pertain to vehicles that have a plurality of wheels in which the suspension for the wheel is biased by a pneumatic spring. Various embodiments pertain to methods and apparatus for safely interlocking the operation of the pneumatic air springs with the controls of the vehicles.

### CROSS REFERENCE TO RELATED APPLICATION

This application claims the benefit of priority to U.S. Provisional Patent Application Ser. No. 61/169,648, filed Apr. 15, 2009; Ser. No. 61/180,212, filed May 21, 2009; Ser. No. 61/224,293, filed Jul. 9, 2009; Ser. No. 61/238,155, filed Aug. 29, 2009; and Ser. No. 61/239,314, filed Sep. 2, 2009, all of which are incorporated herein by reference.

### FIELD OF THE INVENTION

Various embodiments of the present invention pertain to vehicle suspension systems and, in particular to, kits and methods for converting existing suspension systems.

### BACKGROUND OF THE INVENTION

There is a need for vehicles, shuttle buses and school buses that can have a lowered passenger or cargo floor. In some applications, a vehicle chassis is designed and fabricated from the beginning to include a low floor. In yet other applications, an OEM vehicle is modified to have a lowered floor. Sometimes, this is accomplished by cutting through the frame structure of the OEM chassis, and reattaching a lowered rear frame section to a front section that remains at substantially the same height as the OEM vehicle. This cutting and reattachment laterally across the entire frame requires a complex reattachment. In some frames, the reattachment cannot be performed by fusion joining (such as welding), because of the metallurgy of the frame and material. Further, the reattached section of the frame has been relocated to a position where it is permanently closer to the roadway. In some applications, it is preferable to have the frame rails to be higher above the roadway so as to provide a level of crash protection equivalent to that of the OEM vehicle.

What follows are various inventions that provide improved vehicle chassis in novel and unobvious ways.

### SUMMARY OF THE INVENTION

Various aspects of the present invention pertain to methods and apparatus for controlling the floor height of a vehicle having electrically actuatable biasing devices in the vehicle suspension.

Yet other aspects of the present invention pertain to methods and apparatus for converting an existing vehicle to a vehicle that permits a controllable variation in the height and/or pitch angle of the vehicle floor, especially for loading and unloading operations.

Further aspects of some embodiments pertain to vehicles that can be loaded with the vehicle at a lowered position, and operated during driving with the vehicle in a higher position in which portions of the body and frame provide improved crash protection to the occupants or cargo of the vehicle.

One aspect of the present invention pertains to a method of controlling a vehicle suspension. Some embodiments include providing a multiwheeled vehicle having a suspension system including a plurality of pneumatic springs. Other embodiments include substantially deflating at least one of the pneumatic springs while the vehicle is not moving. Yet other embodiments include attempting to drive the vehicle after said deflating and automatically reinflating the one pneumatic spring from the attempt to move the vehicle.

Another aspect of the present invention pertains to a method of controlling a vehicle suspension. Some embodiments include providing a multiwheeled vehicle having a suspension system including a plurality of pneumatic springs, each spring being in fluid communication with an exhaust to ambient conditions. The vehicle includes an operator-actuated control having a plurality of positions. Yet other embodiments include attempting to exhaust gas from the springs when the vehicle is not moving. Still other embodiments include automatically prevent this exhausting of gas based on the position of the control.

Yet another aspect of the present invention pertains to an apparatus for controlling the height of a vehicle. Some embodiments include a multiwheeled vehicle having at least one steerable wheel. Yet other embodiments include a source of pressurized gas, a pneumatic spring for biasing the vehicle to a position, l and an actuatable valve in fluid communication with said source and said spring. Still other embodiments include a sensor for providing a signal corresponding to movement of the steered wheel and actuating the valve based on the angle of the steered wheel.

Another aspect of the present invention pertains to an apparatus for controlling a vehicle suspension. Some embodiments include a multiwheeled vehicle having at least one steerable wheel, a source of pressurized gas, and a pneumatic spring. Still other embodiments include an electrically actuatable valve, and means for interlocking the actuation of the valve.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1 is an illustration of a shuttle bus showing a standard coil spring at running ride height.

FIG. 2 is an illustration of a shuttle bus showing an air spring at running ride height.

FIG. 3 is an illustration of a shuttle bus according to one embodiment of the present invention showing the vehicle at the kneeling position during loading and unloading.

FIG. 4 is an illustration of a school bus according to one embodiment of the present invention showing the vehicle at the kneeling position during loading and unloading.

FIG. 4-2 is a side, perspective photographic representation of a cab and chassis according to one embodiment of the present invention.

FIG. 5 is a photographic representation of a vehicle suspension prior to being modified according to one embodiment of the present invention.

FIG. 6 is a photographic representation of the apparatus of FIG. 5.

FIG. 7 is a photographic representation of a side view of the apparatus of FIG. 5.

FIG. 8 is a photographic representation of the apparatus of FIG. 5.

FIG. 9A is a perspective photographic representation of a known vehicle front suspension.

FIG. 9B is a photographic representation of the front suspension of a vehicle according to one embodiment of the present invention.

FIG. 10A is a perspective photographic representation of a known vehicle rear suspension.

FIG. 10B is a photographic representation of the rear suspension of a vehicle according to one embodiment of the present invention.

FIG. 11 is a photographic representation of a partially converted frame and a wheel chair ramp assembly according to one embodiment of the present invention.

FIG. 11-2 is a photographic representation of a portion of the chassis of FIG. 4-2.

FIG. 11-3 is a photographic representation of a portion of the chassis of FIG. 4-2.

FIG. 11-4 is a photographic representation of a portion of the chassis of FIG. 4-2.

FIG. 11-5 is a photographic representation of a portion of the chassis of FIG. 4-2.

FIG. 11-6 is a photographic representation of a portion of the chassis of FIG. 4-2.

FIG. 11-7 is a photographic representation of a portion of the chassis of FIG. 4-2.

FIG. 11-8 is a photographic representation of a portion of the chassis of FIG. 4-2.

FIG. 11-9 is a photographic plan view of a gusset according to one embodiment of the present invention.

FIG. 11-10 is a side photographic representation of the gusset of FIG. 11-9.

FIG. 11-12 is a passenger-side photographic representation of a portion of the chassis of FIG. 4-2, with the ramp extended.

FIG. 11-13 is a plan view of a doubler according to one embodiment of the present invention.

FIG. 11-14 shows a portion of the chassis of FIG. 4-2 with the doubler of FIG. 11-13 installed.

FIG. 12 is a side view photographic representation of a wheelchair ramp attached to a frame according to one embodiment of the present invention.

FIG. 12-2 is a top plan photographic representation of a ramp-holding tray according to one embodiment of the present invention.

FIG. 12-3 is a photographic representation of the chassis of FIG. 4-2 with the tray of FIG. 12-2 installed.

FIG. 12-4 is a side photographic representation of the apparatus of FIG. 12-2.

FIGS. 13a and 13b are cross sectional views of a vehicle according to one embodiment of the present invention as taken through the frame near the aft end of the wheelchair ramp.

FIG. 14a is a photographic representation looking aft of a portion of a frame and drive train according to one embodiment of the present invention.

FIG. 14b is a close-up right side photographic representation of a portion of the apparatus of FIG. 14a.

FIG. 14-3 is a side photographic representation of a portion of the chassis and drivetrain of the apparatus of FIG. 4-2.

FIG. 14-4 is a top perspective view of the apparatus of FIG. 14-3.

FIG. 14-5 is an end perspective photographic representation of a portion of the chassis and drive train of FIG. 4-2.

FIG. 15 is a photographic representation of the left side of the photograph shown in FIG. 14a.

FIG. 15-2 is a close-up photographic representation of the charcoal canister and cross member of the apparatus of FIG. 4-2.

FIG. 15-3 is an end perspective view of the apparatus of FIG. 15-2.

FIG. 16 is a close-up of the center portion of the photograph of FIG. 14a.

FIG. 17 is a top photographic representation looking aft at a frame according to one embodiment of the present invention.

FIG. 18 is a close-up photographic representation of an engine mount according to one embodiment of the present invention.

FIG. 19 is a side perspective photographic representation looking aft of a frame and suspension according to one embodiment of the present invention.

FIG. 19-2 is a side and top perspective view of a portion of the rear chassis of FIG. 4-2.

FIG. 19-3 is a top and end perspective view of the apparatus of FIG. 19-2.

FIG. 19-4 is a front, side, and top perspective photographic representation of the apparatus of FIG. 19-2.

FIG. 19-5 is a close-up side photographic representation of the apparatus of FIG. 19-4.

FIG. 19-6 is an end photographic representation of the apparatus of FIG. 19-5.

FIG. 19-7 is a close-up photographic representation of a portion of the apparatus of FIG. 19-2.

FIG. 19-8 is a top, close-up photographic representation of a portion of the apparatus of FIG. 19-2.

FIG. 19-9 is a close-up photographic representation of a portion of the apparatus of FIG. 19-2.

FIG. 19-10 is a close-up photographic representation of a portion of the apparatus of FIG. 19-2.

FIG. 19-11 is an end photographic representation looking forward of a portion of the apparatus of FIG. 19-2.

FIG. 19-12 is a top photographic representation of a portion of the apparatus of FIG. 19-2.

FIG. 19-13 is a right side photographic representation looking aft of a portion of the rear chassis of a vehicle according to another embodiment of the present invention.

FIG. 19-14 is a top photographic representation looking downward of the apparatus of FIG. 19-13.

FIG. 19-15 is an end photographic representation looking forward of a portion of the left side of the vehicle of FIG. 19-13, with the wheels removed.

FIG. 19-16 is a side photographic representation of the apparatus of FIG. 19-15.

FIG. 19-17 is an end photographic representation looking aft of the apparatus of FIG. 19-13, with the braking system components removed.

FIG. 19-18 is a top, end photographic representation looking forward of the left side of the vehicle of FIG. 19-13 with the airbag deflated.

FIG. 20 is a side perspective photographic representation of a right front wheel housing according to one embodiment of the present invention.

FIG. 21 is a perspective photographic representation of a replacement airspring assembly according to one embodiment of the present invention.

FIG. 22 is a photographic representation of the airspring assembly of FIG. 21 installed in the wheel housing of FIG. 20.

FIG. 23 is a side photographic representation of the apparatus of FIG. 22.

FIG. 24a is a close-up of a portion of the airspring mount of FIG. 22.

FIG. 24b is a close-up of the airspring mount of FIG. 24a.

FIG. 24-3 is a close-up photographic representation of a portion of the front suspension of the apparatus of FIG. 4-2.

FIG. 24-4 is a close-up photographic representation of a portion of the front suspension of the apparatus of FIG. 4-2.

FIG. 24-5 is a side photographic representation of the apparatus of FIG. 22, on the right side of the vehicle.

FIG. 24-6 is a side photographic representation looking aft of the apparatus of FIG. 24-5.

FIG. 25 is a photographic representation of a vehicle according to another embodiment of the present invention at standard ride height.

FIG. 26 is a photographic representation of the vehicle of FIG. 25 with the rear suspension kneeled.

FIG. 27 is a photographic representation of the vehicle of FIG. 25 with the rear suspension kneeled and the front suspension raised.

FIG. 28 is a photographic representation of the vehicle of FIG. 25 with the full vehicle kneeled.

FIG. 29 is schematic representation of a pneumatic system according to one embodiment of the present invention.

FIG. 30 is a schematic representation of the system of FIG. 29, expressed in standard symbology.

FIG. 31 is a schematic representation of the panel wiring schematic for an electropneumatic system according to one embodiment of the present invention.

FIG. 32 is a wiring harness schematic for an electropneumatic system according to one embodiment of the present invention.

FIG. 33 is a wiring system diagram of an electropneumatic system according to one embodiment of the present invention. FIG. 34a is a logic flow chart describing operation of a safety interlocking system according to one embodiment of the present invention.

FIG. 34b is a logic flow chart describing operation of a safety interlocking system according to one embodiment of the present invention.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, in discussion pertaining to a specific composition of matter, that description is by example only, does not limit the applicability of other species of that composition, nor does it limit the applicability of other compositions unrelated to the cited composition.

The use of a 0 or 1 prefix for an element number (0Y.YY or 1Y.YY) refers to an element that is from the original equipment manufacturer (OEM) for the vehicle.

One embodiment of the present invention pertains to the modification of an OEM chassis in order to provide additional functionality. In one embodiment, the chassis includes a pair of longitudinally-extending frame rails that provide primary support for the vehicle body and suspension. In one embodiment, a notched portion is removed from one of the frame rails (the right frame rail for vehicles designed to be driven on the right side of the road, and likewise for the left side), with the cutout of the frame rail subsequently being reinforced to maintain the fundamental load path of the OEM vehicle after modification. A deployable ramp, such as a wheel chair ramp adapted and configured to meet ADA requirements. The innermost end of the ramp is coupled to the chassis proximate to the notch. During deployment, the ramp translates or unfolds from its stored position to a position extending outside of the vehicle body.

In some embodiments, the notch is cut into the side rail of the OEM frame, and that side rail is not completely cut through horizontally. Further, the side rail on the other side of the OEM chassis remains substantially unmodified from the OEM configuration. However, the present invention also contemplates those embodiments in which the side rail notch is created with a complete cut through the rail. However, even in these embodiments, the subsequent reattachment (including the notch for the ramp) is accomplished with the modified side rail being at substantially the same vertical height as it was in its OEM configuration. Maintaining this OEM height, during normal operation (transporting) of the vehicle is helpful in some embodiments since the frame side rails impart improved crash worthiness to the entire vehicle, especially for side impacts. This is a helpful aspect of such embodiments, especially when the vehicle is used for transporting passengers such as school children.

Yet other embodiments of the present invention pertain to modifications on an OEM chassis such that the chassis can be lowered to a position that is lower than the lowest position of the OEM chassis. In some embodiments, this includes removing spacers that are attached on top of the frame rail and that hold up the floor of the vehicle body. In yet other embodiments, the suspension is modified to remove various bump stops. In yet other embodiments, the OEM bump stops are replaced with bump stops of a smaller thickness.

In yet other embodiments, the ability of the modified chassis to be brought closer to the road level than the OEM chassis includes modifications to the springs of the OEM vehicle. In one embodiment, the metal springs of the front suspension (such as coil springs) are removed and replaced with air springs. Further, such modified suspensions further include one or more attachment brackets that accommodate an air spring to fit within a previously established spring pocket. In one embodiment, there are brackets at both the top and the bottom of the front air spring that allow both interfacing of the air spring to the pocket, and which further allow pneumatic connections to either the top or the bottom of the spring. Further yet, in some embodiments the brackets can include spacing plates that provide lateral stability for the stacked assembly of air spring and top and brackets relative to moving parts of the suspension, such as a steering knuckle.

Yet other embodiments of the present invention pertain to modifications to the rear suspension of an OEM chassis. In some embodiments, the OEM rear suspension includes multi-leaf springs that couple a tube axle to the side rails. In some embodiments one or more of the attachment points, such as the front attachment point, are moved on the frame rail to a position closer to the bottom of the rail. In yet other embodiments one or more leaves of the leaf spring are removed, so as to reduce the stiffness of the spring. In some embodiments, the spring stiffness is reduced such that the modified leaf spring by itself is incapable of keeping the rear suspension from bottoming out with a normal load in the body. In such embodiments a rear air spring is added and located such that it biases the aft end of the leaf spring (or trailing arm) from a location on the frame side rail.

In some embodiments, the front and rear suspensions of the OEM vehicle are modified such that the vehicle from can rise higher than the OEM frame (such as in rebound), and further moved to a lower position than the OEM chassis (such as during jounce). In such embodiments, and especially those in which the rear suspension is of the trailing arm type, the OEM suspension is modified to include a vertically aligned bracket with a flat lateral face. In such modified suspensions, a rub block, such as a block with smooth surfaces fabricated from an ultra-high molecular weight polyethylene is attached to either the bracket or to the opposing vertically aligned face of the side rail. During rebound and jounce of the suspension, the rub block rubs against either the face of the bracket (if it is attached to the frame) or against the frame (if it is attached to the bracket). The rub block maintains a lateral spacing relationship between the trailing arm and the frame. Since rub blocks are preferably installed on both right and left sides of the rear suspension, these rub blocks assist in maintaining lateral stability of the tube axle.

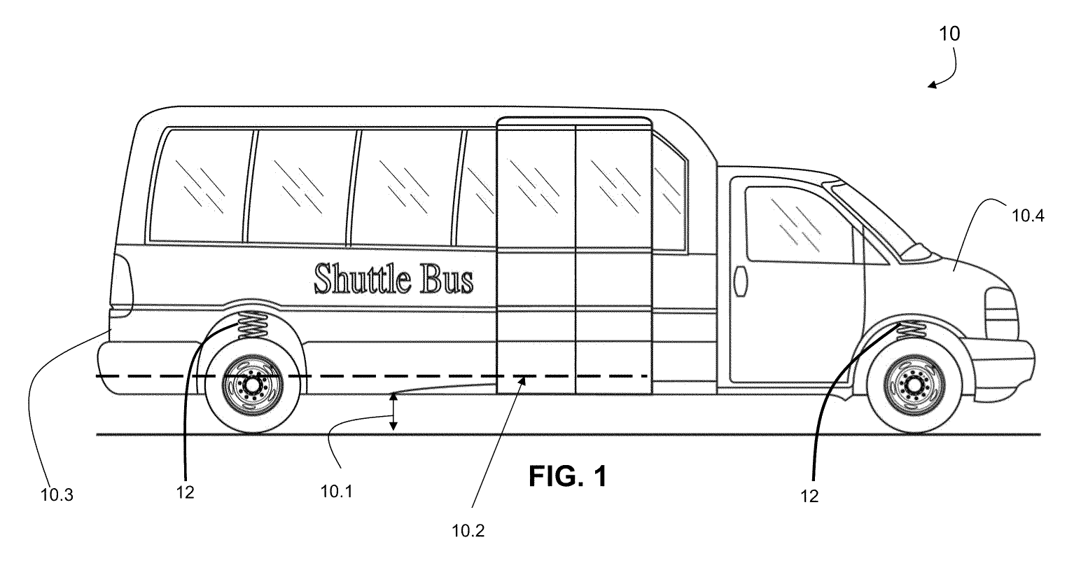

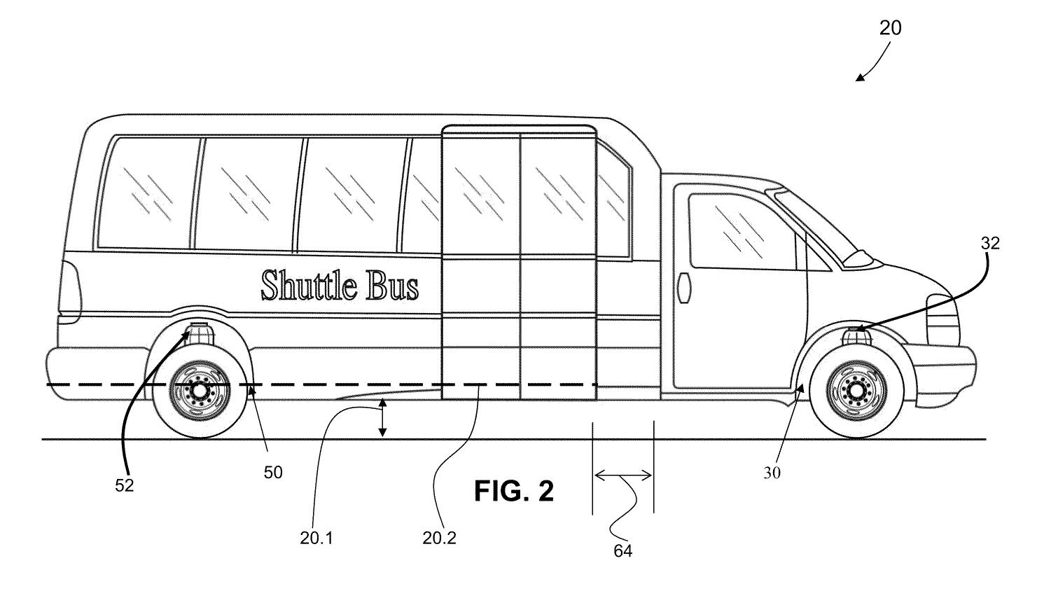

FIG. 1 shows a conventional transit bus 10 used for transporting people short distances. Preferably, bus 10 is adapted and configured by a gross vehicle weight rating (GVWR) in excess of about 8,500 pounds. Vehicle 10 includes a driver's compartment and engine compartment located forward of a passenger compartment. Vehicle 10 is supported from the roadway by front and rear suspensions. In some vehicles, a coil spring 12 is placed between a portion of the body or frame and an attachment point on the suspension and biases the vehicle 10 to a ride height 10.1. In many applications, the suspensions of vehicle 10 permit a dynamic up and down travel of the vehicle of plus or minus one and one-half inches about the static ride height. Should there be a large disturbance to the suspension, various elements of the suspension system encounter a mechanical stop (such as elastomeric bump stops), or in the case of coil springs solid compression of the coils. Further, the level of the passenger floor 10.2 is often above the centerline of the wheels and is high enough that passengers leaving the vehicles make a large step. For those vehicles 10 that include provisions for wheelchair access, there is often a complicated, articulating elevator ramp 10.3 provided for safe transition of the wheel chair from floor 10.2 down to the surface of the roadway.

FIGS. 2-8, 9B, and 10B depict various views of apparatus according to various embodiments of the present invention. Referring to FIG. 2, there is shown a shuttle bus 20 that is based upon vehicle 10 as previously described, but including a conversion kit and method 21 that modifies front suspension 30 and rear suspension 50. As can be seen in FIG. 2, one aspect of the conversion kit includes replacement of coil springs 12 (for those vehicles that originally included coil springs) with front and rear air springs 32 and 52, respectively. In yet other embodiments, vehicle 20 can include modifications to leaf springs, and further include modifications to bump stops and other components as will be described herein.

In one embodiment of the present invention, there is a conversion kit and method for modifying the suspension system of an existing vehicle. By incorporating this conversion kit, the modified vehicle has greatly increased total travel of the suspension system. In one embodiment, the inside floor 20.2 of the vehicle can move 8 inches from a high body position to a low body position. In yet other embodiments, the level of the vehicle can change 15 inches from the high body position to the low body position.

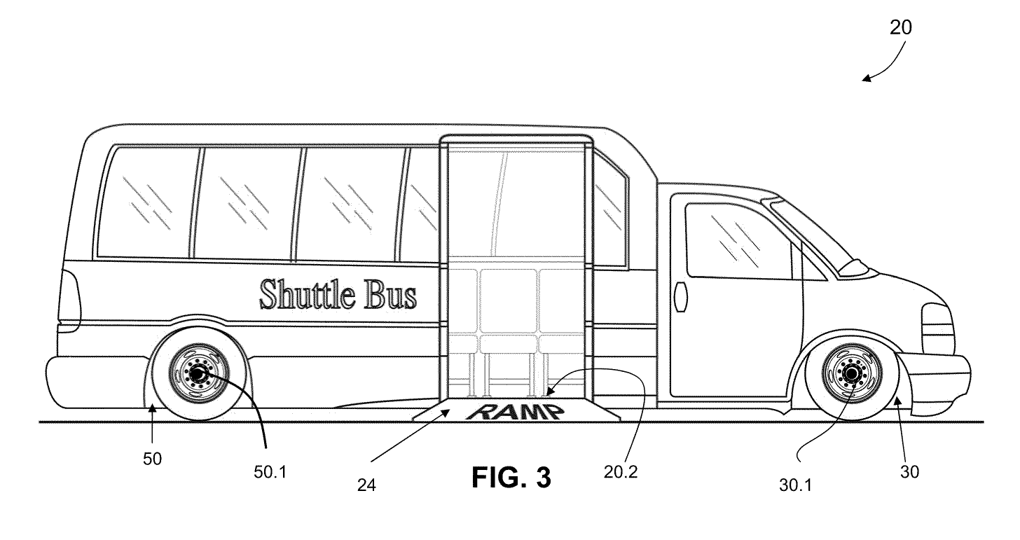

Referring to FIG. 3, vehicle 20 is shown in the low body position. The entry of the internal floor 20.2 of the passenger compartment is lower than the rotational axes 30.1 and 50.1 of the front and rear suspensions, respectively. In a vehicle 20 including the conversion kit, a simple unfolding wheelchair ramp 24 extending from a door (such as the side door shown in FIG. 3) can meet the federal requirements for wheelchair access, and the more complicated articulating and elevating wheelchair apparatus 10.3 (as discussed with regards to FIG. 1) is not required.

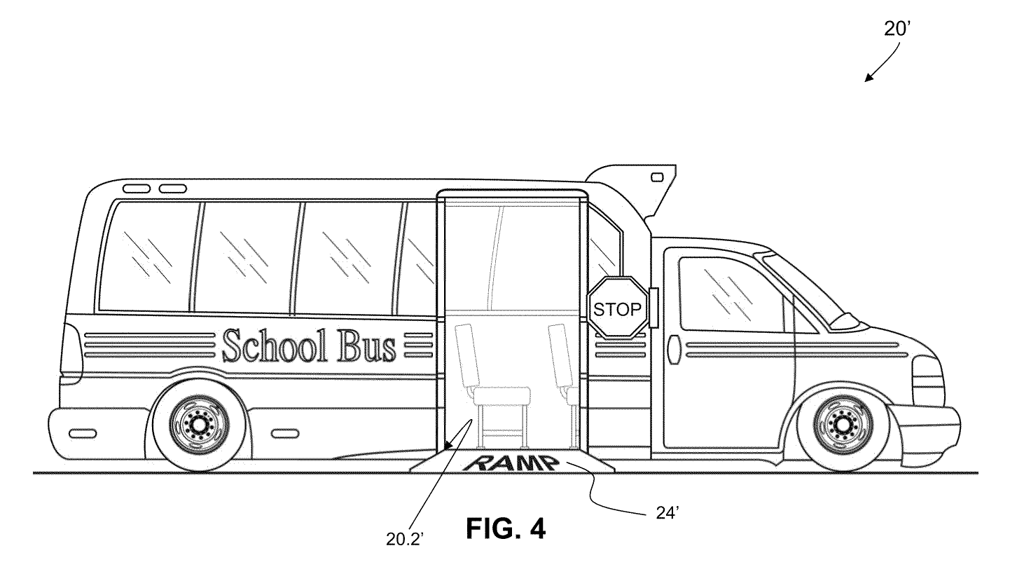

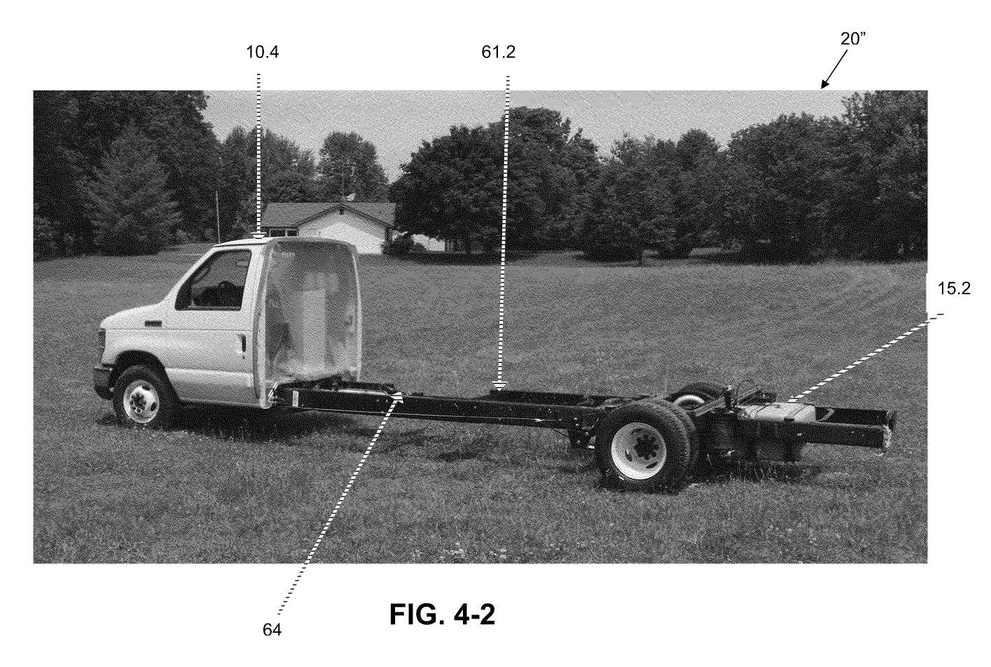

Referring to FIG. 4, there is shown a vehicle 20′ such as a school bus that incorporates a conversion kit according to one embodiment of the present invention. As discussed with regards to FIG. 3, a simple unfolding wheelchair ramp 24′ provides ADA access for a wheelchair from the road surface to the internal floor 20.2 of the passenger compartment. When school bus 20′ is returned to a ride height or a high body position, the internal floor 20.2′ is at a height above the road surface sufficient to meet the typical crash protection standards for school buses. In such embodiments, the conversion kit and method permits any school bus to be simply and economically modified for wheelchair access, yet further retain the safety consideration standard in the industry.

FIG. 4-2 is a photographic representation of a portion of a vehicle 20″ according to another embodiment of the present invention. FIG. 4-2 shows a cab 10.4 coupled to a frame 60. Frame 60 has been modified to include an extension assembly 64 that lengthens the distance from the back of cab 10.4 to the rear wheels. Frame 60 has further been modified to include a cutout 62.1 in the right frame rail 61R.

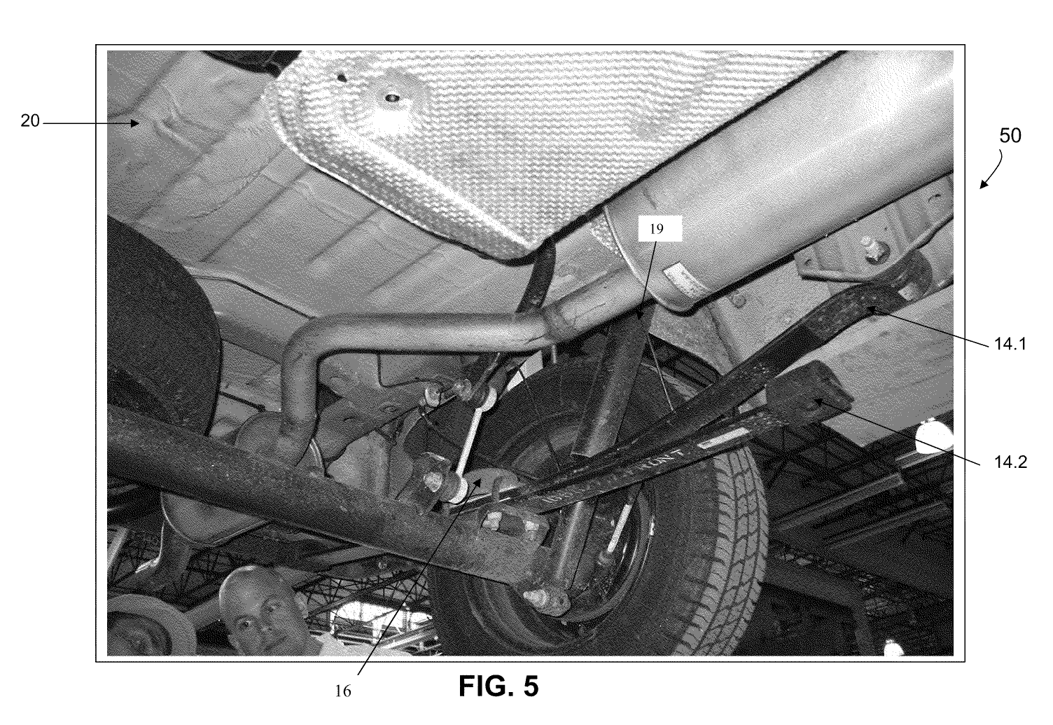

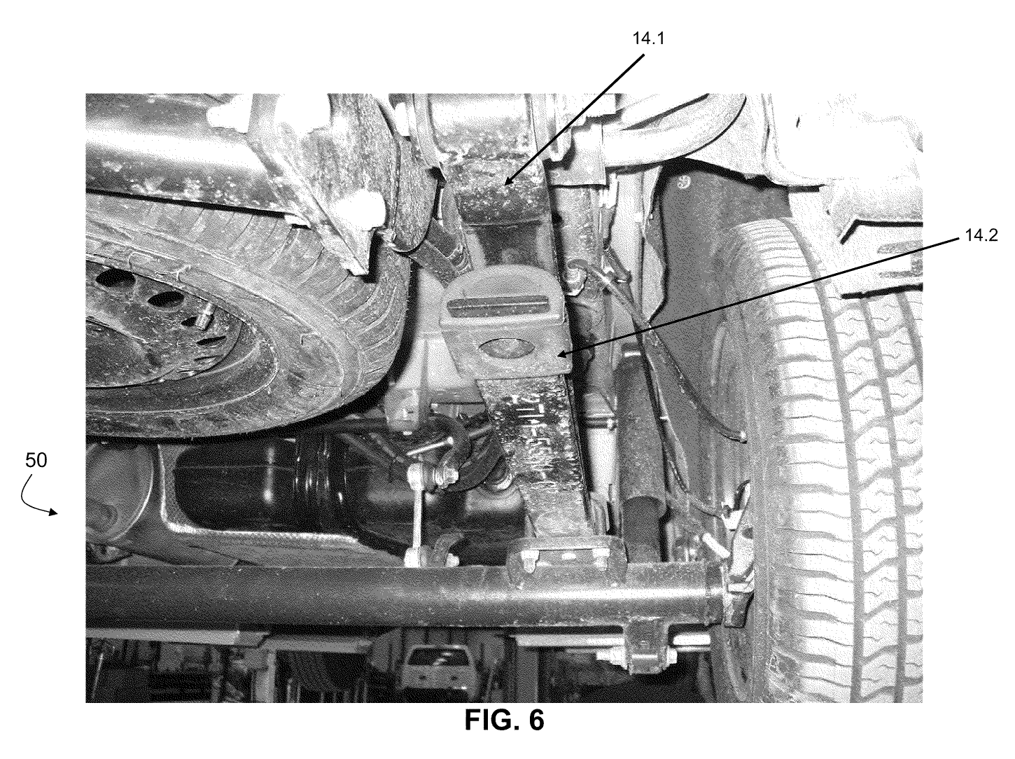

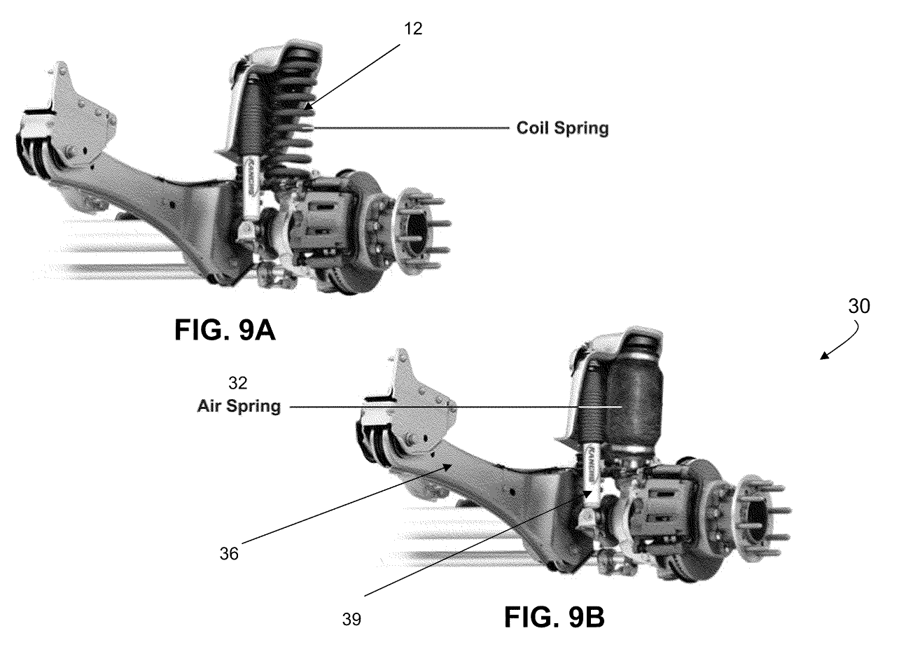

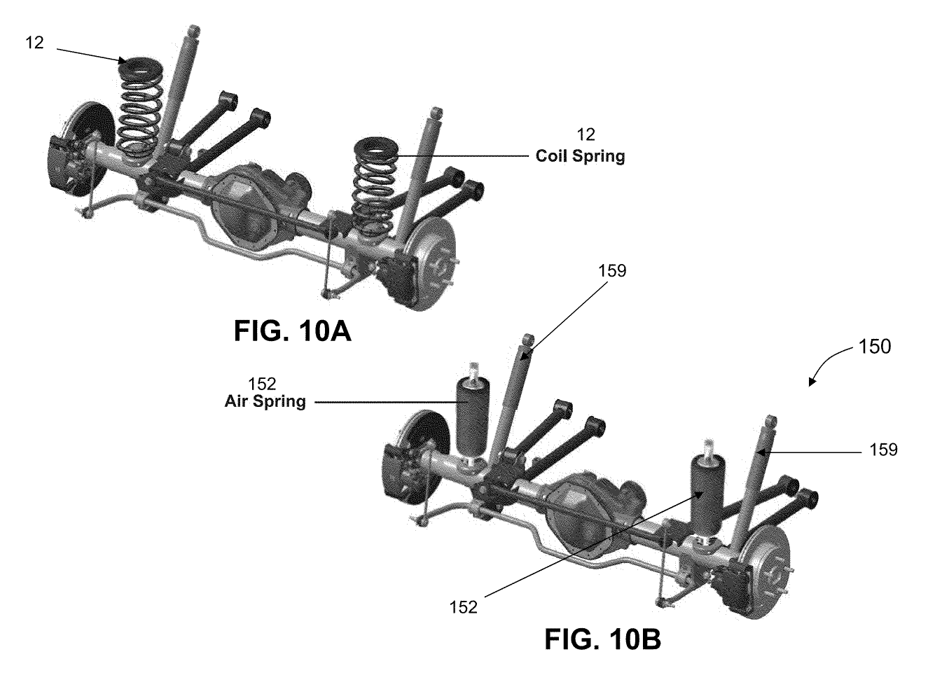

FIG. 5-8 are various photographic representations of vehicle 20 in the process of being modified to include a conversion kit according to one embodiment of the present invention. Referring to FIG. 5, a rear suspension 50 is shown. A tube axle 51 connects the right and left rear wheels. Tube axle 51 preferably includes a mounting apparatus 54 for attaching leaf springs 14.1 and 14.2 to the top surface 51.1 of tube axle 51. In the vehicle 20 shown (a Ford transit connect) there are two leafs: a first leaf 14.1 interconnected to attachment apparatus 54 and further connected to the chassis of vehicle 20, and also a second leaf spring 14.2 that is attached to apparatus 54, but not attached to the chassis of the vehicle, and further not attached to the first leaf spring. Bottom leaf spring 14.2 includes rubber grommets (as best seen in FIG. 6) at each end, these grommets coming in contact with the underside of leaf 14.1 during compression of suspension 50. Although a rear suspension 50 having two leaf springs is shown and described, other embodiments of the present invention contemplate different arrangements of leaf springs, and also contemplate the use of coil springs (as will be discussed with regards to FIGS. 9 and 10).

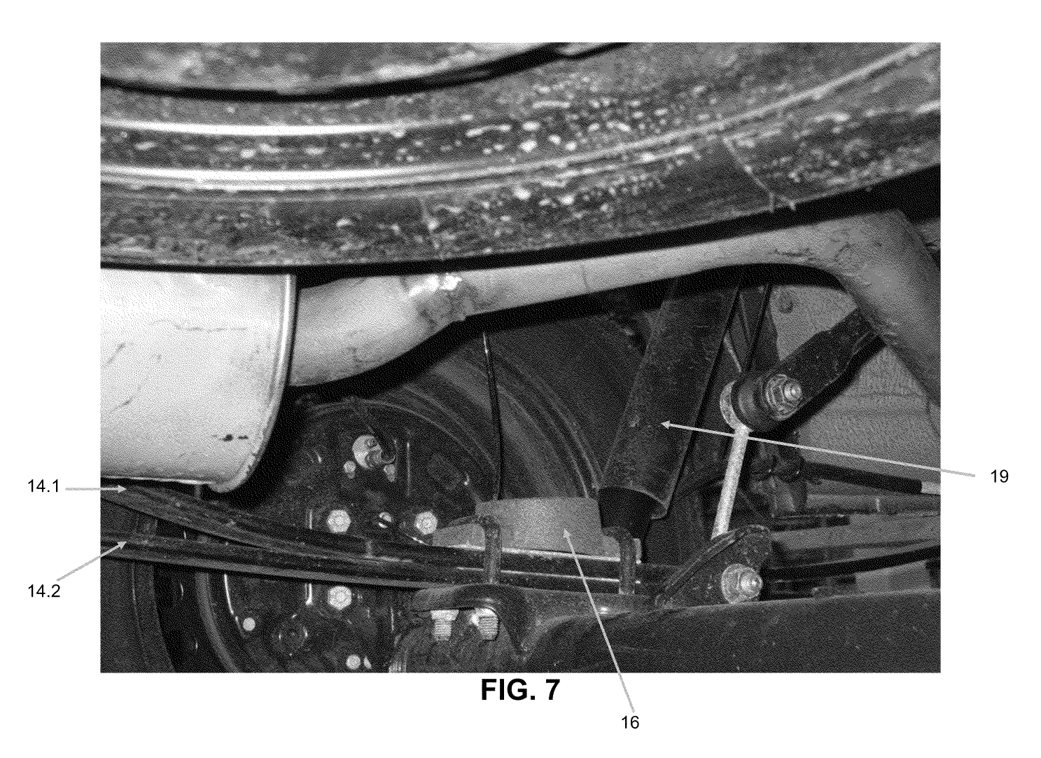

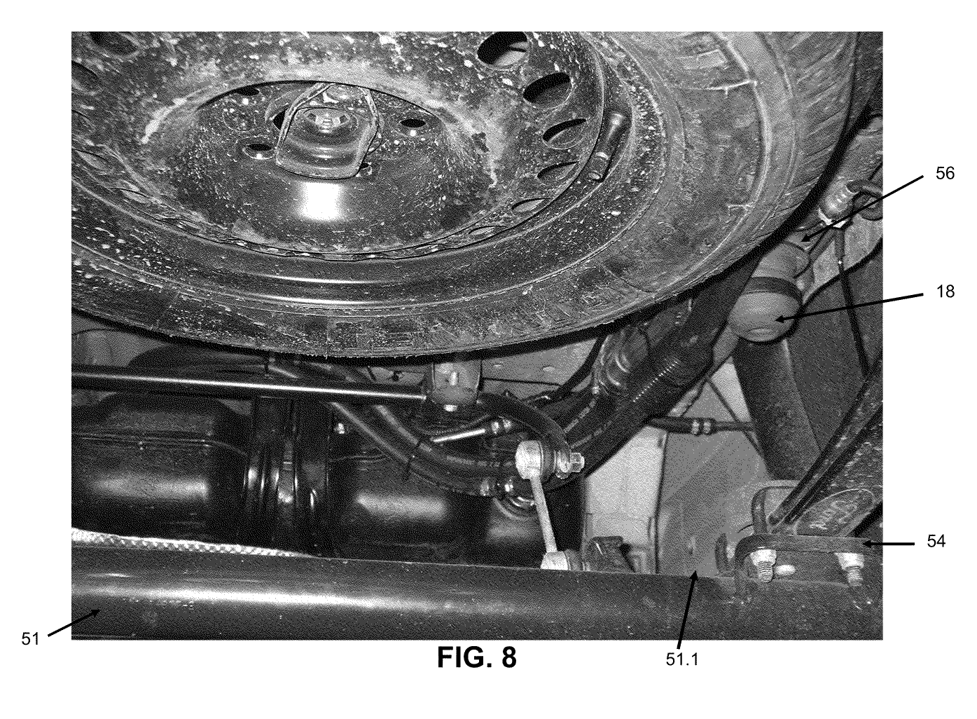

Referring to FIGS. 5 and 7, it can be seen that a bottom bump stop 16 is further coupled to the top of leaf spring 14.1. Prior to conversion, vehicle 20 further includes an upper bump stop 18, as best seen in FIG. 8. Upper bump stop 18 is coupled by attachment 56 to the body of vehicle 20. In the unmodified vehicle, bump stops 16 and 18 function to limit the compression of suspension 50, and therefore also establish the extent to which the vehicle can drop to a low body position. Furthermore, in an unmodified vehicle, vehicle 10 will not stay in position with the bump stops in contact, because of the action of leaf springs 14.1 and 14.2 to bias apart tube axle 51 from the chassis of the vehicle.

In a conversion kit and method according to one embodiment of the present invention, suspension 50 is modified to remove both the lower and upper bump stops 16 and 18, respectively. Further, leaf spring 14.2 is removed. Upper leaf spring 14.1 is retained. One embodiment of the present invention includes retention of at least one leaf of the leaf springs so as to continue to provide the guidance and stability to tube axle 51 during travel of suspension 50.

The conversion kit includes an air spring 52 (not shown in FIG. 5-8) that is attached to generally the same attachment points 54 and 56 that previously held bump stops 16 and 18. Further, some kits include a replacement for existing shock absorber 19, in those cases where the existing shock absorber does not have sufficient travel to accommodate the suspension modified by the conversion kit.

A conversion kit further includes a source of compressed air (such as an air pump driven by an electric motor), an electronic controller, sensing devices (such as height sensors, pressure sensors, and switch position sensors), and an electronic controller. In some embodiments, the electronic controller of the pneumatic system exchanges data with a vehicle computer. Referring to FIG. 2, during normal transport operation, the electronic controller maintains sufficient air pressure in the air springs 32 and 52 to achieve a desired ride height (in the case of school bus 20′, the height during transport is sufficient to meet the typical safety standards).

Preferably, the controller of the pneumatic system receives signals from a vehicle computer that give the status of various operator inputs. In one embodiment, the position of the transmission gear selector and the position of the ignition key are provided. Preferably, the controller of the pneumatic system does not permit deflation of the air springs unless the transmission is in the park configuration. In yet other embodiments, deflation is further not permitted unless the ignition switch is in the off position. One or both of these safety interlocks (or corresponding interlocks, such as with regards to position of the parking brake) do not permit the vehicle to drop to the fully lowered body position unless it is safe to do so. For some of the conversion kits and methods described herein, the vehicle should not be driven in the low body position.

The controller of the pneumatic system can adjust the air pressure in any or all of the air springs, including singly and in pairs (such as front versus rear, or left versus right). Further, the controller can include software to permit the ride height of the vehicle to be relatively constant regardless of the amount or location of passenger loads.

When vehicle 20 is stopped, the electronic controller of the pneumatic system can completely collapse air springs 32 and 52, such that vehicle 20 drops to a low body position that is lower than the lowest position attainable by the suspension of unmodified vehicle 10. This reduction in height by the low body position is achievable for a number of reasons. First, the air spring is completely deflated and provides no biasing force to push apart the mounting surfaces 54 and 56. Further, the single remaining leaf spring 14.1 has inadequate stiffness by itself to bias apart the body from the tube axle. Further, the low body position is established by the internal bump stops of the air springs. When the air spring is completely deflated, the sides of the air spring fall outwards away from the center of the air spring. The air springs 32 and 52 each include internal bump stops proximate their top and bottom attachment points (respectively, to attachment points 56 and 54). The compressed height of the air spring is much less than the height of the bump stops 16 and 18 that have been replaced. Therefore, the modified suspension permits a significant reduction in the low body position of the internal floor of the vehicle.

In some embodiments, the leaf spring attachment 54 can include structure that places the leaf springs several inches above the top surface 51.1 of the tube axle (as best seen in referring to FIG. 8, which includes a relatively low attachment point 54). In those cases where attachment point 54 is at a position extended away from the top surface 51.1 of tube axle 51, the conversion method according to one embodiment of the present invention includes modifying the extended support structure to a position closer to (or preferably, coincident with) the top surface 51.1 of tube axle 51. In yet other vehicles, similar modifications may be made to the attachment 56 that couples the upper bump stop of the unmodified vehicle. In those vehicles where the attachment 56 extends the bump stop downward and away from the body, the upper attachment 56 can be modified so that the attachment surface for the replacement air spring is closer to the body of the vehicle.

FIG. 9A shows a conventional front suspension (such as the one shown in FIG. 1), and a modified version of that same suspension is shown in FIG. 9B. The standard suspension of vehicle 10 includes a coil spring 12 that biases apart a trailing arm from the vehicle frame. In a modification kit according to one embodiment of the present invention, coil spring 12 is replaced with an air spring 32 that biases apart a trailing arm 36 from the vehicle frame. Further, the conversion kit can include a replacement shock absorber 39 that provides an extended range of travel commensurate with the modified suspension. In some embodiments, suspension trailing arm 36 includes one or more bump stops (either on the arm or on the vehicle body, or on both). The conversion process can also include modification of these bump stops, including removal of these existing bump stops.

FIG. 10A shows a standard rear suspension system of a vehicle such as vehicle 10. A pair of coil springs 12 bias apart a live axle from the underside of the chassis of the vehicle. Referring to FIG. 10B, a rear suspension 150 according to one embodiment of the present invention includes a pair of air springs 152 that replace coil springs 12. Further, a pair of replacement shock absorbers 159 with extended range can also be included in the conversion kit.

Various embodiments of the present invention include one or more of the following aspects:
1. While in transport mode—the entry floor of the passenger compartment is above the rotational axis of the front and rear wheels
2. While in load/unload mode—the entry floor of the passenger compartment is below the rotational axis of the front and rear wheels
3. Load/unload ramp is positioned between the front wheels and the rear wheels
4. Electrical interlock which prevents the vehicle from entering the transport mode when the vehicle is in the load/unload mode
5. Electrical interlock which prevents the load/unload ramp from deploying in the vehicle's transport mode
6. In the transport mode—the vehicle's rear frame rail and body support structure height is at a level which adds a level of protection for the vehicle and its passengers from side impact collisions from other vehicles
7. In load/unload mode—the vehicle's rear frame rail height is lowered to provide curb entry access for wheel chair bound students
8. In the rear suspension—the air spring mounts upwardly at a position nearest the planar bottom surface of the passenger floor supported from the vehicle's main frame rail
9. In the rear suspension—the air spring mounts downwardly at a position nearest the rotational axis of its corresponding wheel, preferably at a position directly attached to the rear wheel axle housing
10. In the front suspension—the air spring mounts upwardly at a position between the top planar surface of the vehicle's main frame rail, and the bottom planar surface of the vehicle's main frame rail
11. In the front suspension—the air spring mounts downwardly at a position nearest the rotational axis of its corresponding wheel, preferably at a position directly attached to the front wheel axle housing
12. A rear wheel drive vehicle which has a drive line arrangement having constant velocity (CV) joints which positions the drive line (prop shaft) always in the load/unload relationship to the vehicle's frame
13. A vehicle which transports people with physical disabilities, who may use wheelchairs, walkers, etc. —having a passenger compartment “floor” which is level without slopes

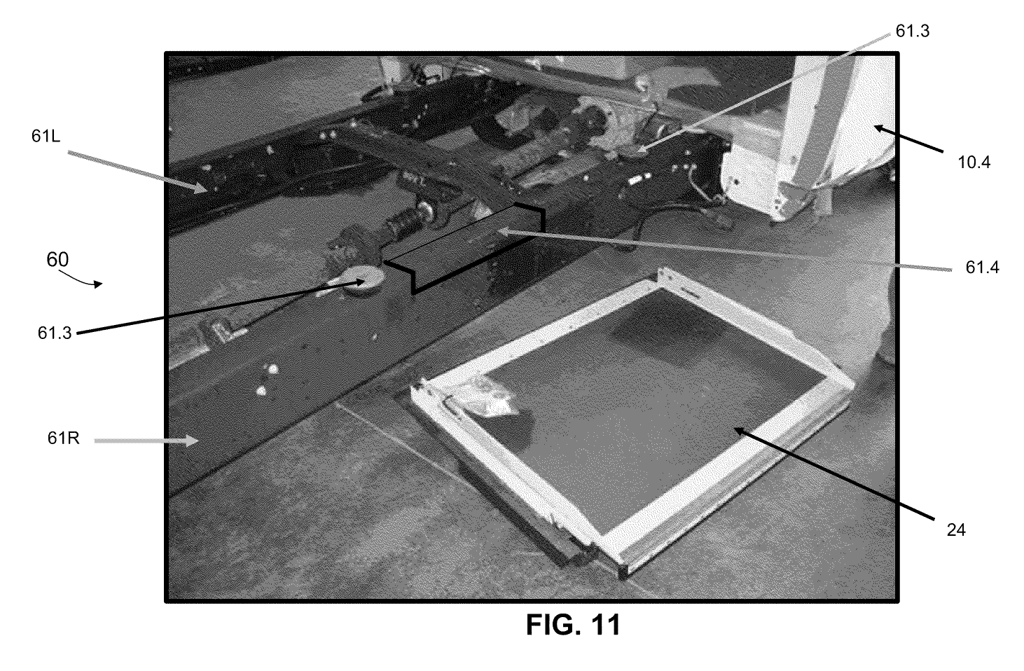

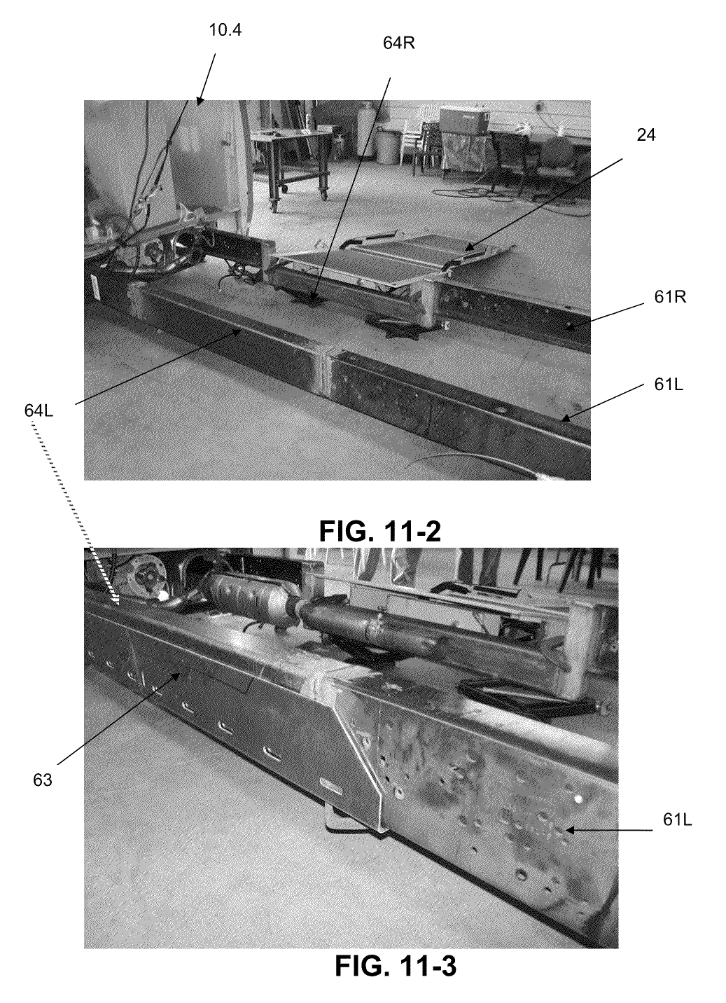

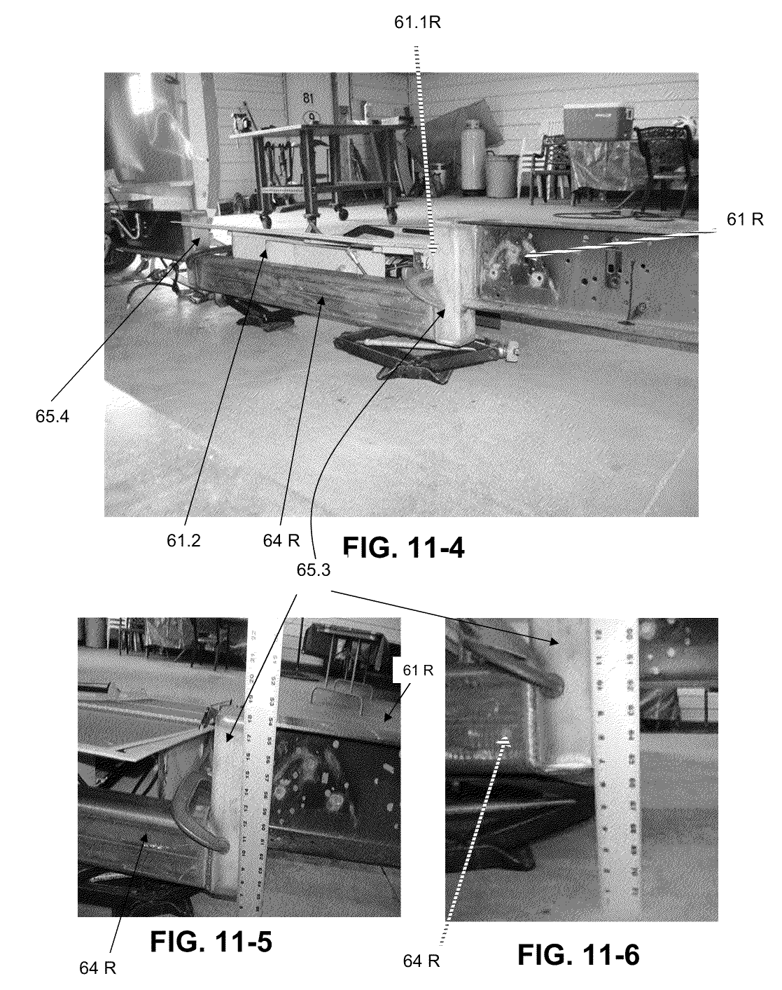

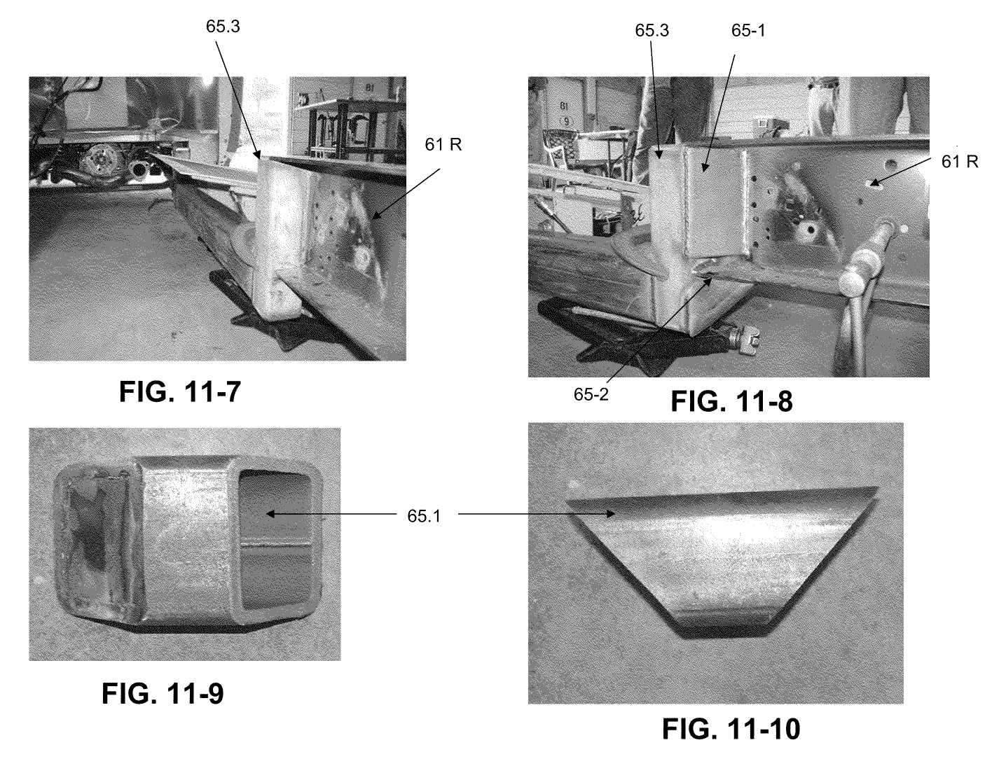

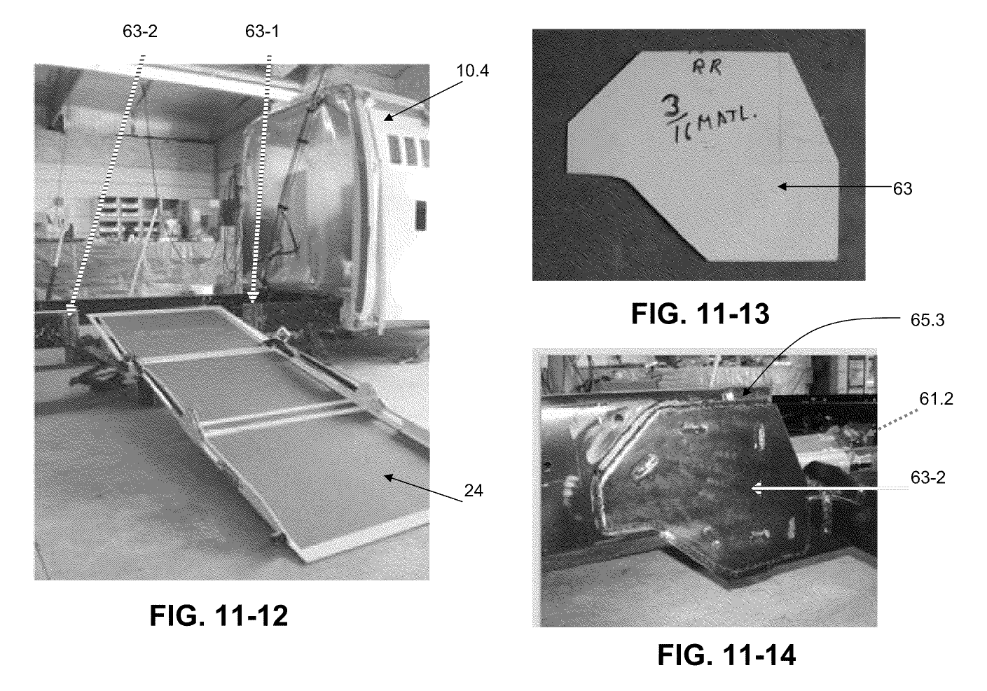

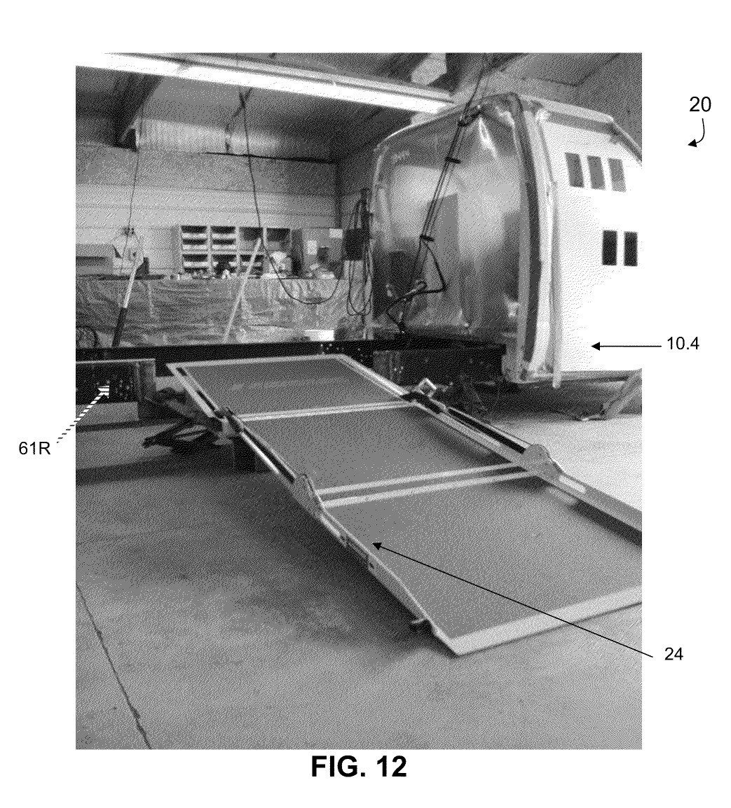

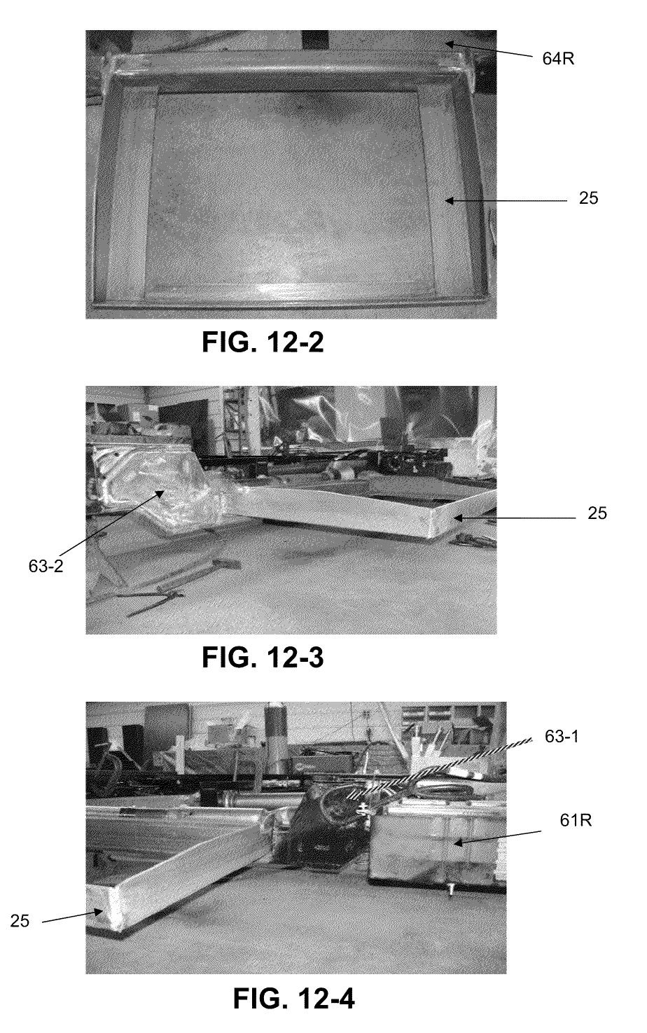

FIGS. 11, 12, and 13 show various aspects of a frame 60 and ramp 24 according to one embodiment of the present invention. A wheelchair ramp such as a Braun RA300® is shown sitting next to a frame 60 in FIG. 11, and shown attached to that same frame in FIG. 12. FIG. 11 shows left and right main side frame rails 61L and 61R, respectively, extending from Cab 10.4 to the rear of the vehicle (in the left of FIG. 11). In one embodiment, a notch 61.4 is cut out of side rail 61R in order to accommodate the installation of ramp 24. In FIG. 11 the notch has not been cut out, but is instead indicated by thick lines (further, the notch is shown schematically, and not to scale).

Although what has been shown and described is an unfolding wheel chair ramp 24 having three pivotally-coupled leaves, other embodiments of the present invention contemplate unfolding ramps with only two sections, ramps that are pivotally coupled to the body, and swing downward for deployment, and further ramps slide out from a pocket within the body or chassis. Further, although a wheel chair ramp extending from a side of the vehicle (and especially the right side of the vehicle in countries where cars drive on the right side of the road, and out of the left side of the vehicle in those countries in which the vehicles are driven on the left side of the road), the present invention also contemplates those embodiments in which the wheel chair ramp extends or unfolds from a rear facing door. Further, although the use of wheel chair ramps are shown and described herein, other embodiments of the present invention contemplate the use of cargo ramps that are adapted and configured for removing vehicles by a two wheeled hand cart.

FIGS. 11-2 through 11-14 are photographic representations of various portions of the chassis in FIG. 4-2, and in some cases portions of the chassis at intermediate stages of modification. FIGS. 11-2 and 11-3 show a midsection of frame 60 as viewed from the left outboard side of vehicle 20″. FIG. 11-2 shows the insertion of an extension section 64L into side rail 61L. A longitudinal extension portion 64R has been placed within a cutout of side rail 61R. FIG. 11-3 shows the placement of a strengthening doubler 63 that overlaps extension 64L and the OEM portion of side rail 61L. Doubler 63 is welded in place.

FIGS. 11-4 to 11-8 show various photographic representations of the inboard side of a portion of the right side rail of chassis 60 of vehicle 20″. As best seen in FIGS. 11-4 and 11-7, main side rail 61R has been cut apart as indicated by arrow 61.1R and a longitudinal extension 64R has been inserted. Extension 64R is placed between and welded to vertically oriented gussets 65.3 and 65.4, these gussets also closing off the cut made onto OEM side rail 61R. Extension 64R is vertically displaced downward so as to create a pocket 61.2 for ramp 24. FIGS. 11-5 and 11-6 are photographic representations of the aft end of pocket 61.2 in relation to a measuring instrument marked in inches.

FIGS. 11-7 to 11-10 are photographic representations depicting the attachments and reinforcements between OEM side rail 61R and the extended pocket 61.2. FIG. 11-7 shows the inboard view facing forward of the attachment of side rail 61R to gusset 65.3 and extension 64. In FIG. 11-8, a pair of gussets 65-2 and 65-1 have been welded in place. Each of these gussets are welded to both frame 61R and gusset 65.3. Gusset 65-1 has a triangular cross-section and extends from the inboard-most corner of gusset 65.3 to the inboard surface of rail 61R. Gusset 65-2 (which is also shown in FIGS. 11-9 and 11-10) also has a triangular cross-section, and is welded in place from the bottom horizontal flange of rail 61R to the lower aft face of gusset 65.3.

FIGS. 11-2 through 11-14 depict the strengthening applied to the outboard side of side rail 61R. A pair of doubler plates 63-2 and 63-1 are placed over and welded to the outer face of doubler 65.3 and the outer face of the OEM portion of rail 61R.

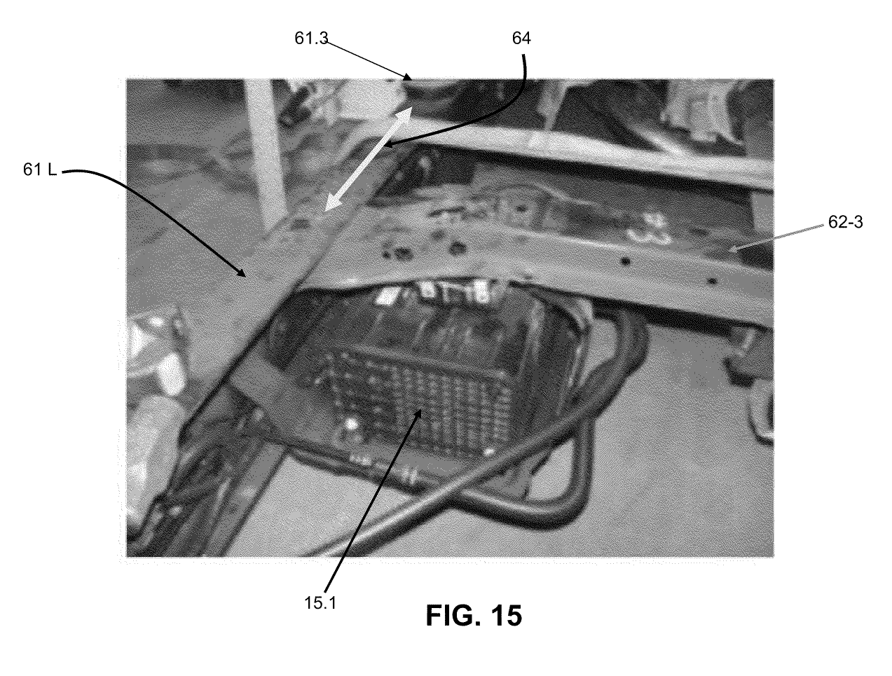

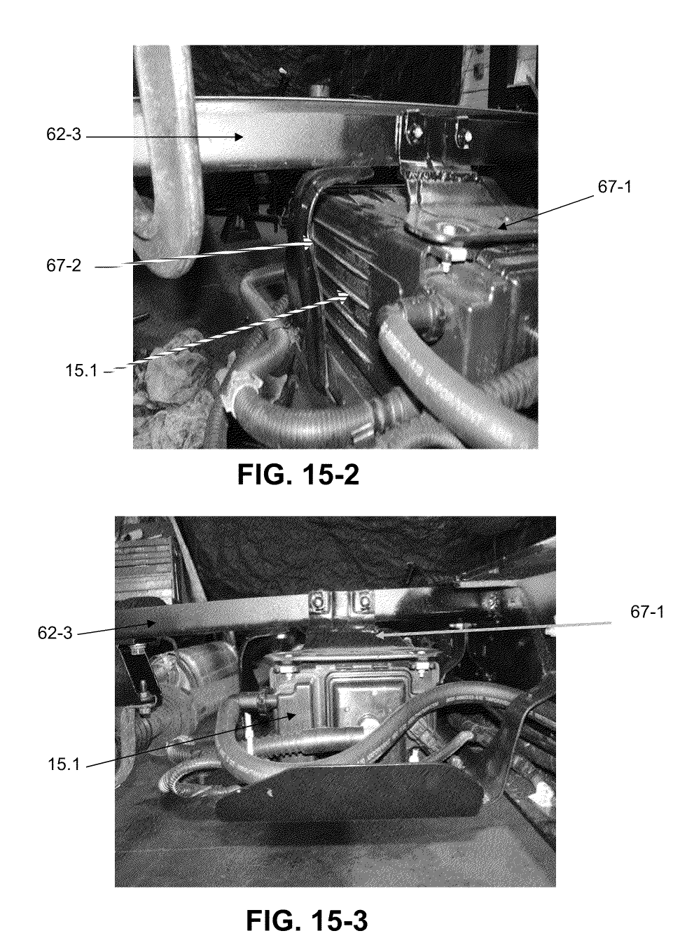

Referring to FIG. 12, ramp 24 is shown in the unfolded and extended position, such as would be the case for ingress and egress from vehicle 20. Referring again to FIG. 12, vehicle 20 includes a frame extension kit that extends the length of the frame about fifty inches, thus permitting placement of the ramp immediately behind Cab 10.4 by about twenty eight to thirty inches. This distance is also shown in FIG. 2 and FIG. 15.

Although what has been shown and described is a ramp 24 that is located generally within a pocket fabricated into a side rail, the present invention is not so limited. Yet other embodiments contemplate the use of unfolding ramps and slidably deployable ramps on vehicles whose frames are not notched.

FIGS. 12-2 through 12-4 depict a ramp enclosure 25 attached within pocket 61.2. Ramp enclosure 25 is generally a shallow, open-bottom, five sided box that is welded onto frame extension 64R. Enclosure 25 contains ramp 24 in the folded or nested position.

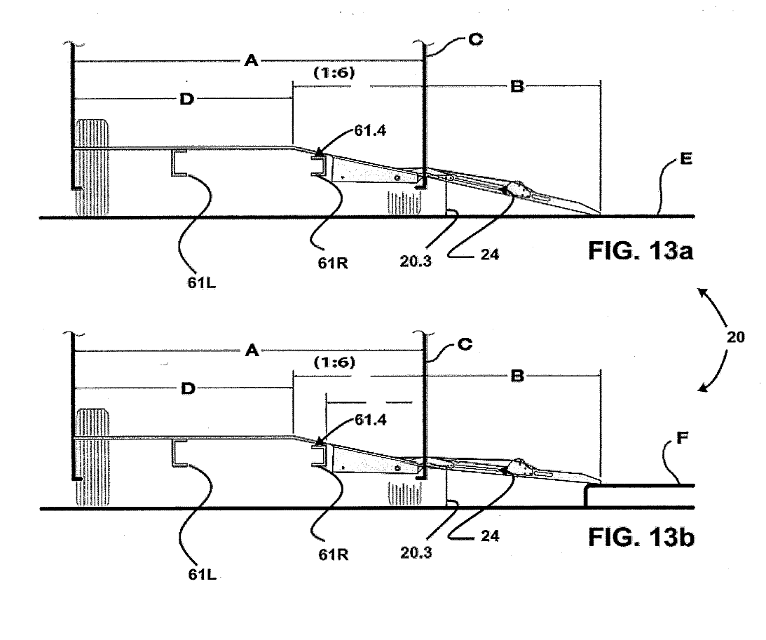

FIGS. 13a and 13b show the extended and unfolded ramp 24 in cross-sectional views of Vehicle 20. It can be seen that notch 61.4 is about 2.5 inches to 3 inches of the top portion of side rail 61R and extends across the lateral width of side rail 61R. These figures show that the ramp, in one embodiment, extends about 48 inches from the side of the vehicle body, and extends from the vehicle body into the interior of the vehicle by about 36 inches. In both FIGS. 13a and 13b vehicle 20 is shown in the fully kneeled position, with all air springs deflated. As shown, the ground clearance from the bottom of side rail 61L to the roadway surface is about ten inches. Referring to FIG. 13a, if the end of the ramp 24 touches at ground level, then the angle of the ramp has a minimum rise overrun of 1:4 (i.e., the angle is the arctangent (0.25)), which meets or exceeds requirements of the Americans with Disabilities Act. Referring to FIG. 13b, if the end of ramp 24 is extended to a 6 inch high curb, then the ramp rise over run is a ratio of 1:8 (corresponding to a ramp angle of arctangent (0.125)), which also meets ADA requirements. As can be seen in both FIGS. 13a and 13b, the step-in floor height 20.3 from the roadway to the bottom of the portion of the ramp within the vehicle body is about 12 inches. With the vehicle in the fully kneeled position, this step-in floor height of 12 inches is below the rotational axis of the wheels of the vehicle.

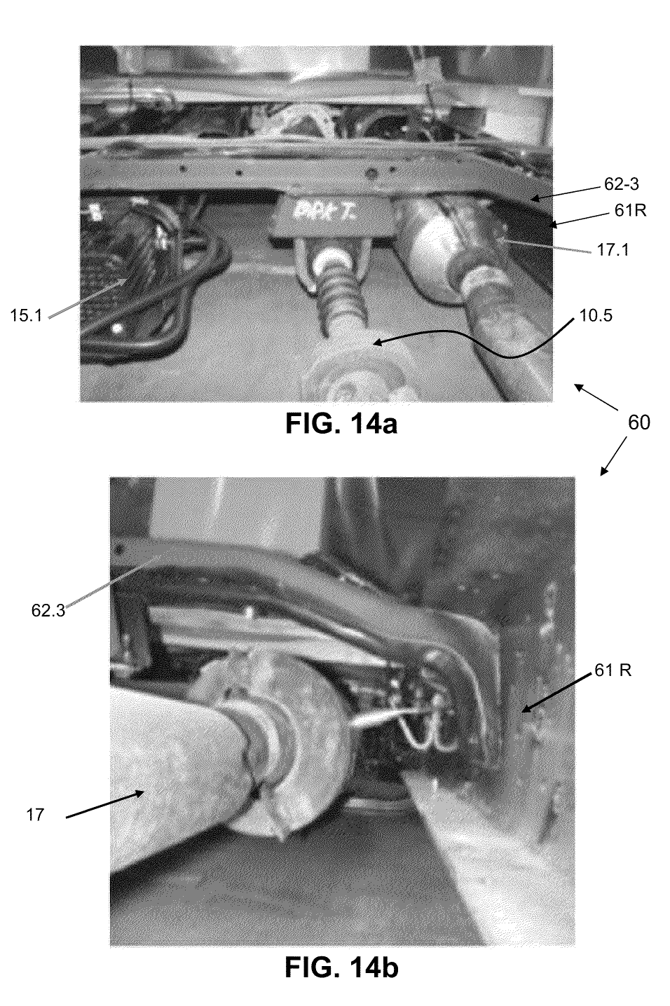

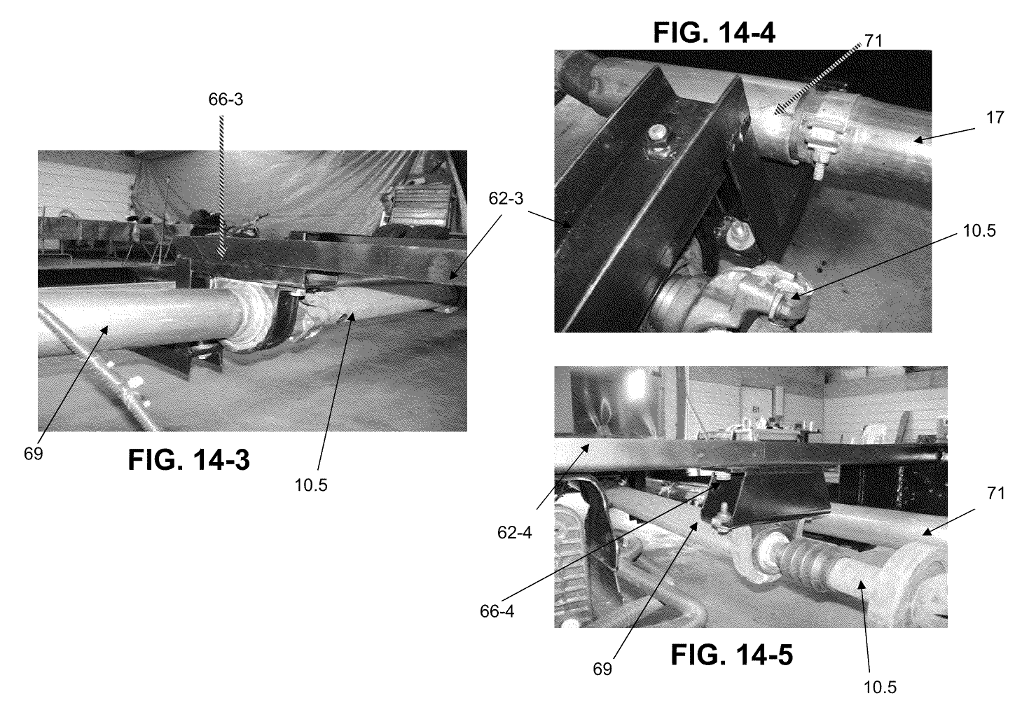

FIGS. 14, 15, 16, 17, 18, and 19 depicted various aspects of the frame, suspension, drive train, and frame-mounted components according to one embodiment of the present invention. FIG. 14a shows a portion of the chassis of vehicle 20 as observed by a viewer standing in about the center of the frame and looking aft. A cross member 62-3 extends laterally across frame 60 from side rail 61L to side rail 61R (not shown). The designation of −3 refers to the third cross member of a Ford E 450 series frame, counting cross members consecutively from just aft of the cab.

FIGS. 14-3 to 14-5 are photographic representations of modified cross members of chassis 60 that support driveshaft 10.5. The length of driveshaft 10.5 is increased by the use of an extension 69. Frame cross members 62-3 and 62-4 are placed at the forward and aft ends of extension 69, respectively. The extended driveshaft of vehicle 20″ is coupled by a bearing and bracket 66 to cross member 62-3, and by a bearing and a bracket 66-3 to cross member 62-4. As best seen in FIG. 14-4, cross member 62-3 extends over the extended driveshaft and under extension 71 of exhaust system 17. Cross members 62-3 and 62-4 are each welded, bolted, or fastened to side rails 61L and 61R.

Placed underneath cross member 62-3 is a catalytic converter 17.1, drive shaft 10.5, and charcoal canister 15.1. FIG. 14b shows the connection of cross member 62-3 to side rail 61L, and also shows how cross member 62-3 arches upward toward the middle of the cross member, to a height that is above the top surface of side rail 61L. In some embodiments of the present invention, cross member 62-3 is replaced with a different cross member that maintains a profile laterally across frame 60 such that the top surface of the cross member does not extend above the top surface of either side rail 61L or 61R. This can be accomplished by removing the OEM cross member and welding, bolting or fastening it or otherwise attaching it to the side rails at a lower position. In yet other embodiments, the OEM cross member is replaced with a cross member that does not include the arched-up profile between the side rails. Further, in some embodiments the replacement side rail is made from a thicker and/or stronger material to replace any stiffening or strength that was lost in replacing the OEM cross member.

FIG. 15 shows the middle portion of cross member 62-3 extending to side rail 61L. FIG. 15 is a view looking down and forward on a left hand portion of frame 60. The charcoal canister 15.1 can be seen mounted under cross member 62.3. In some embodiments, charcoal canister 15.1 is retained with substantially the original mountings so as to retain its location relative to the engine and fuel tank of the vehicle. Preferably, the fuel hoses connected to canister 15.1 are the OEM fuel lines. FIG. 15 also shows by way of arrow 64 the position along the length of frame 60 where a fifty inch extension is installed. This extension is preferably installed forward of canister 15 and aft of Cab 10.4.

FIGS. 15-2 and 15-3 show the attachment of canister 15.1 to cross member 62-3 of vehicle 20″. Canister 15.1 is coupled to cross member 62-3 by a top bracket 67-1 and a side bracket 67-2.

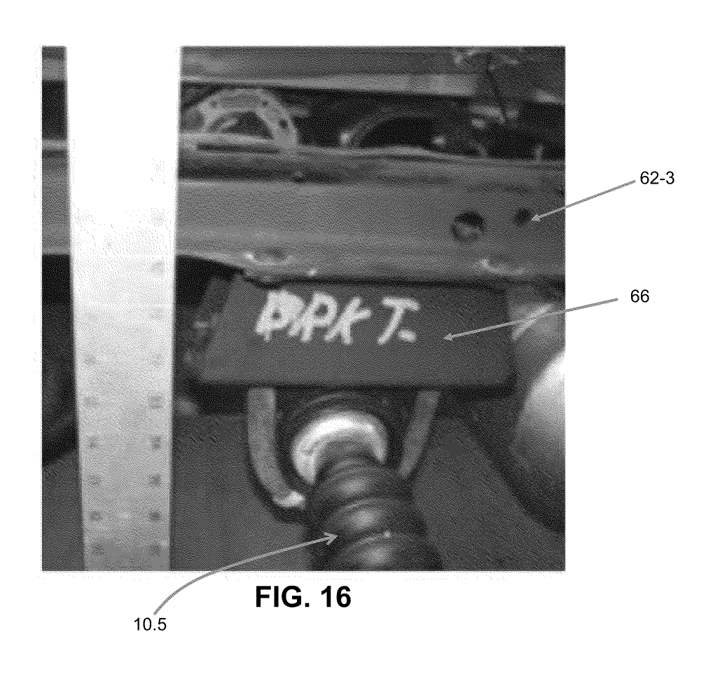

FIG. 16 shows a bracket 66 that retains drive shaft 10.5 to cross member 62-3. As previously discussed, cross member 62-3 replaces the OEM third cross member and has a top surface lower than the top surfaces of the right and left side rails 61. This change in the cross member is accompanied by a change in bracket 66 so as to maintain the height of drive shaft 10.5 as approximately the same as the OEM height above the roadway surface.

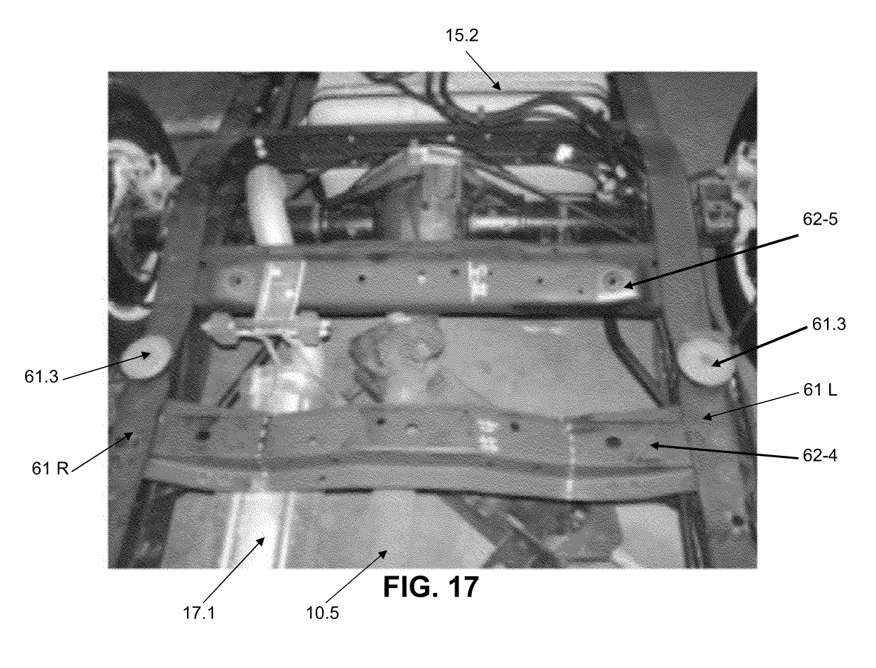

FIG. 17 is a view looking down and aft along the aft portion of frame 60. Side rails 61R and 61L can be seen extending rearward toward fuel tank 15.2. The rear axle extends laterally across the frame side rails. The OEM frame includes a plurality of puck-shaped resilient spacers 61.3 that sit between the top surface of the side rails and the undersurface of the vehicle body. These spacers are preferably removed in vehicle 20 and therein assist in reducing the step-in-height of the kneeled vehicle (as best seen in FIGS. 13a and 13b). Preferably, the structural body compartment of shuttle bus 20 sits in metal to metal contact on top of side rails 61L and 61R, instead of the OEM arrangement that has the pucks 61.3 inbetween the body and the side rails.

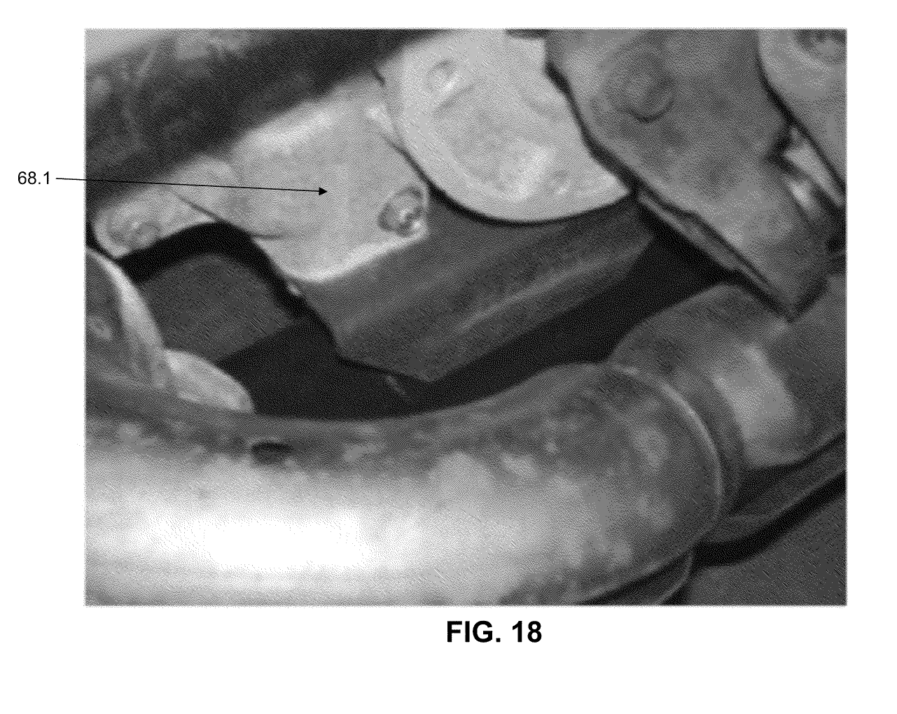

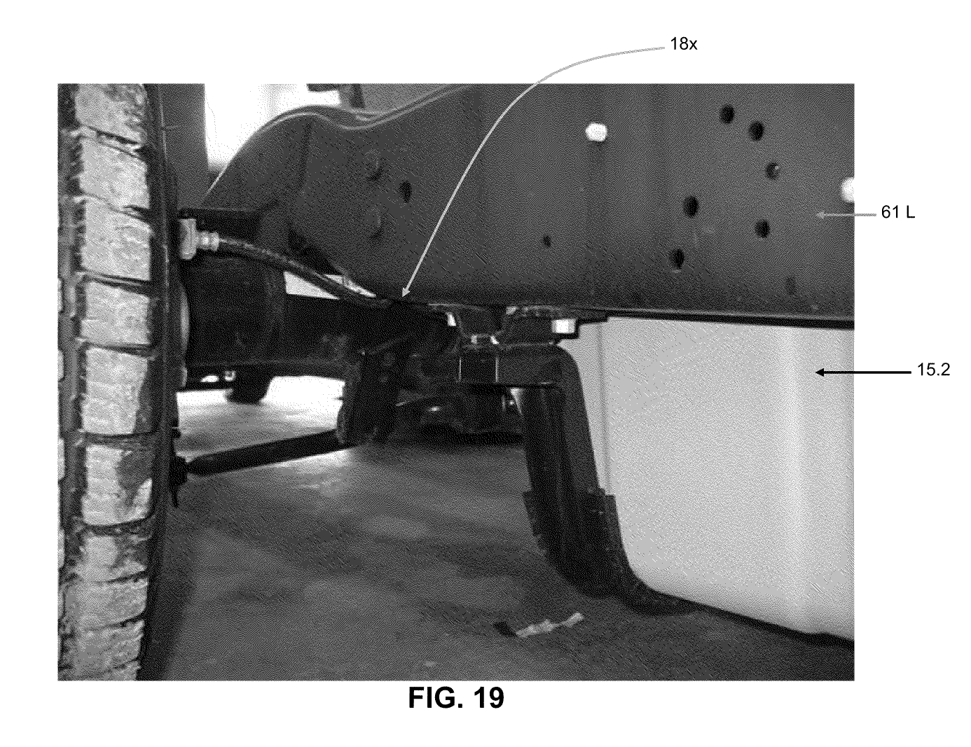

FIG. 18 shows an engine mount 68.1 that couples the engine of vehicle 20 to frame 60. In one embodiment, the engine mounts are altered so as to lower the engine about one half to one and one half inches from the OEM position of the engine. The transmission mounts (not shown) are similarly altered to support the transmission as attached to the lowered engine.

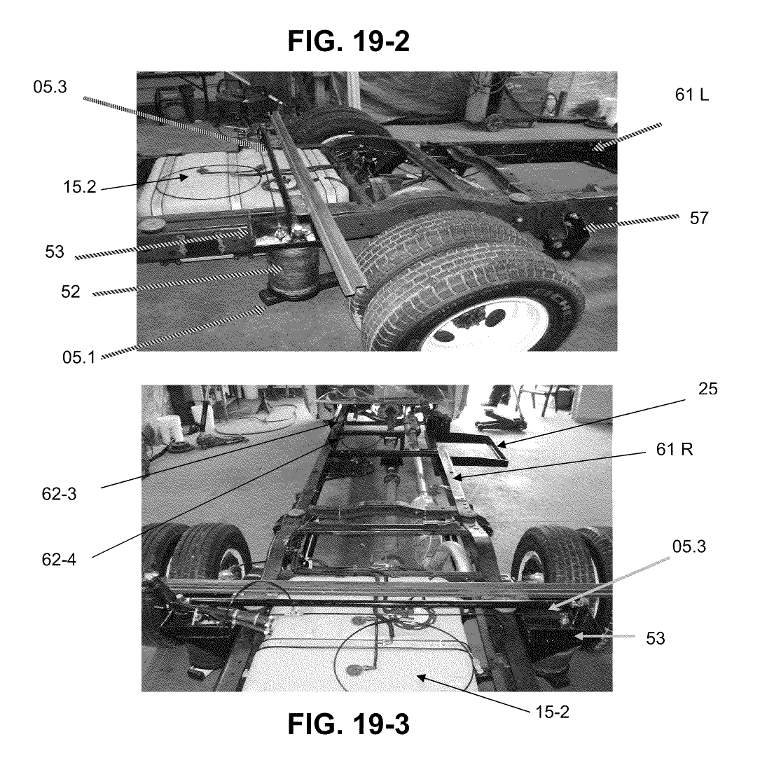

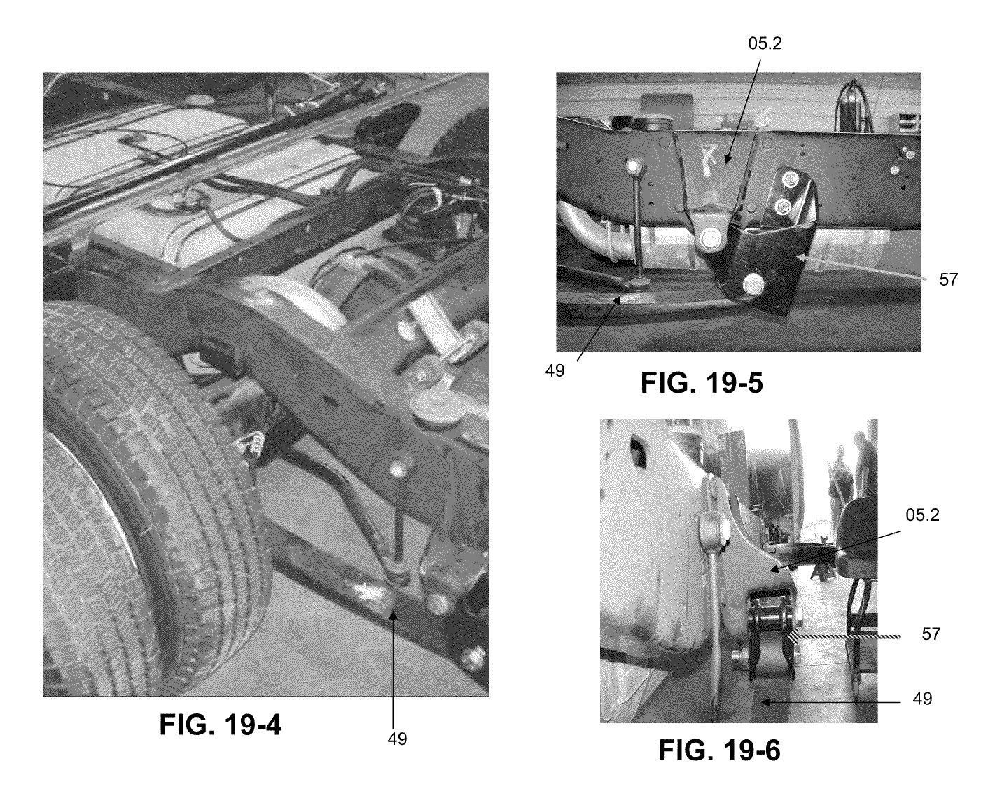

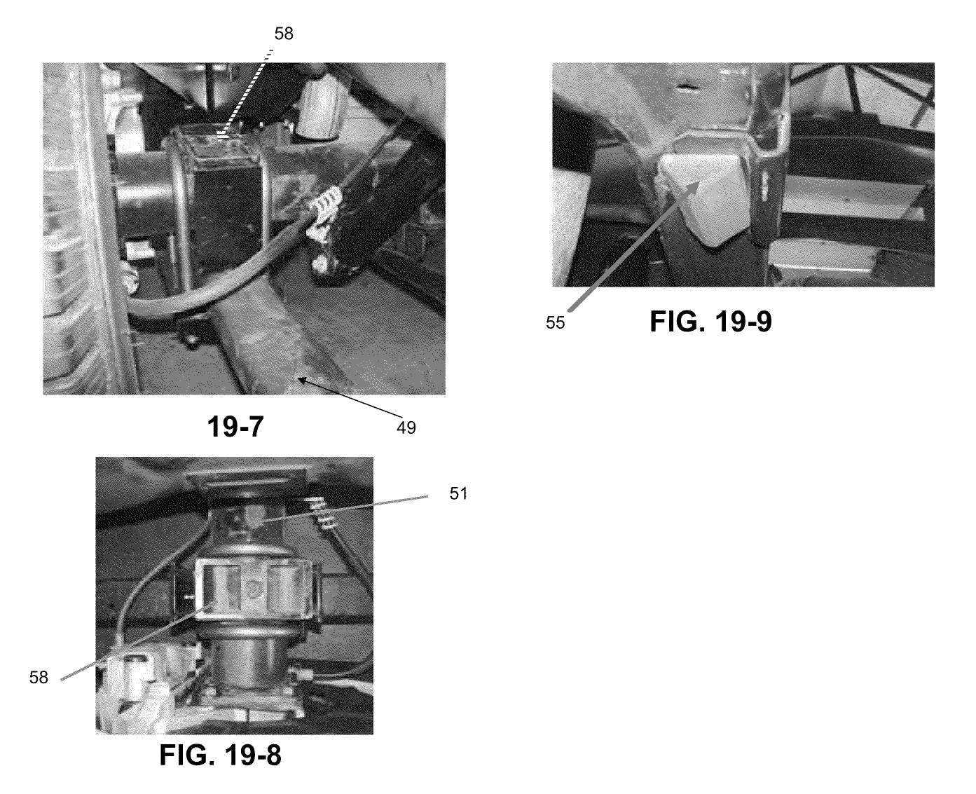

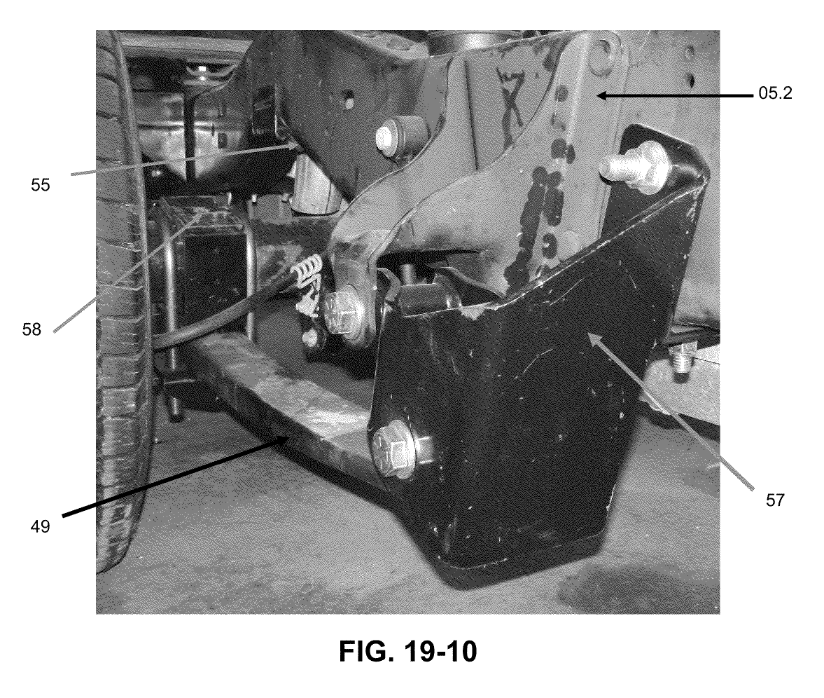

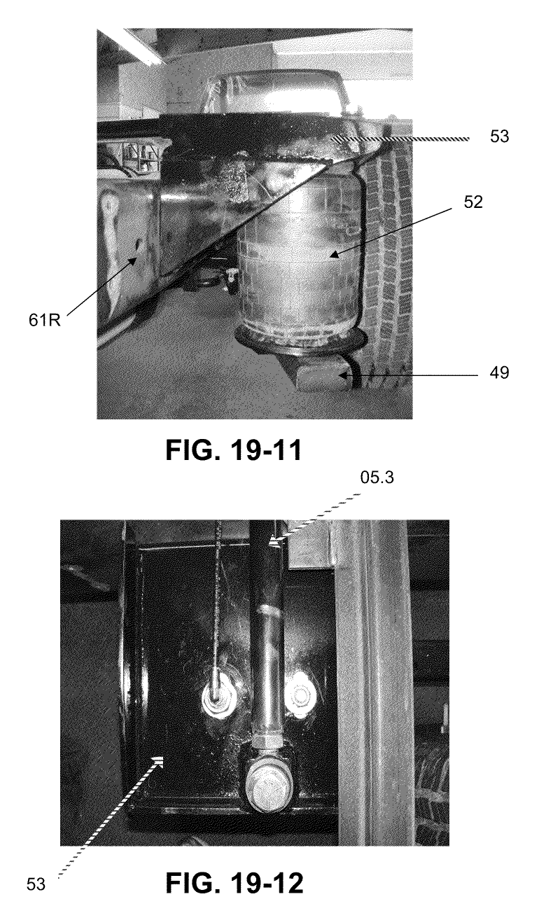

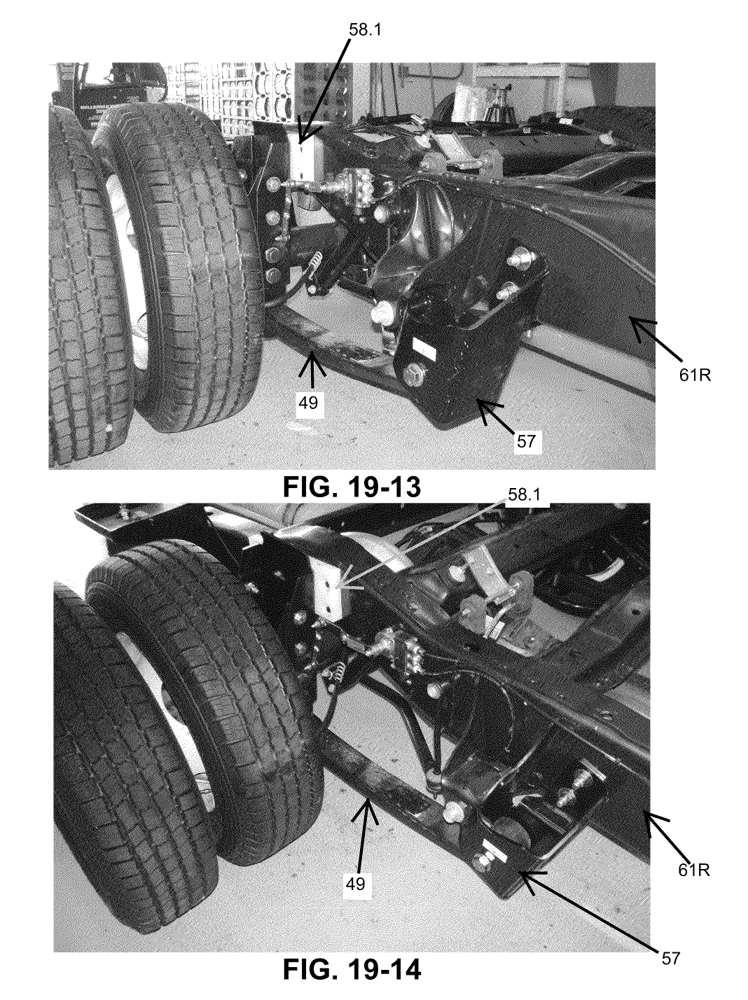

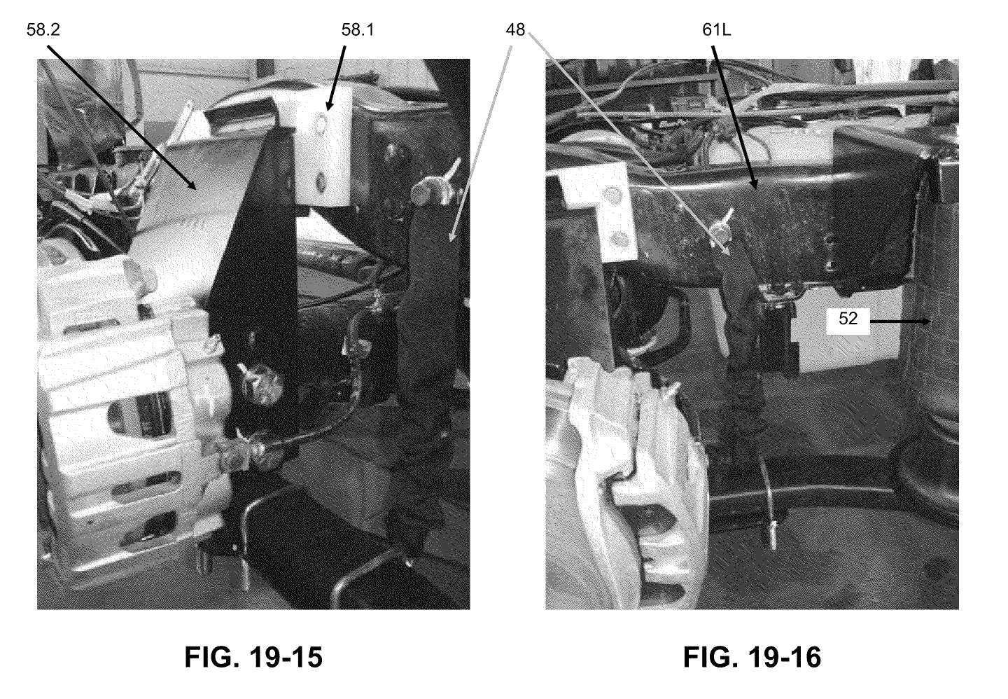

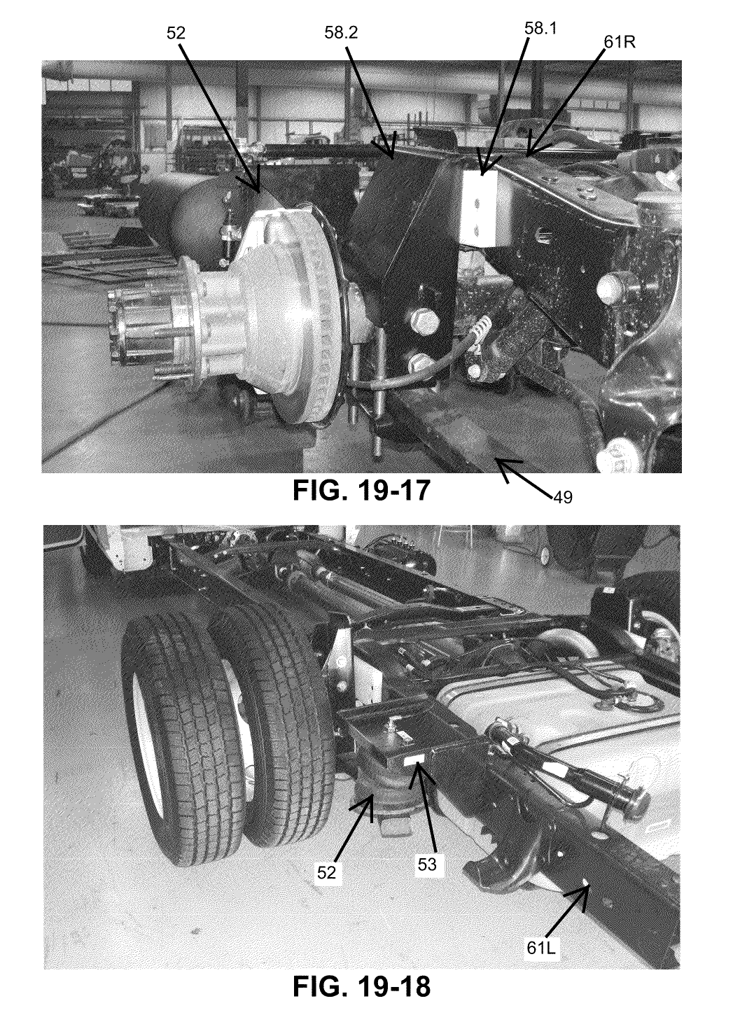

FIG. 19 is a view of the vehicle from the right side looking aft. The fuel tank 15.2 is attached to side rail 61R. The left side rear wheel can be seen in the left of FIG. 19. Arrow 18x points to a location that in the OEM vehicle included a bump stop. However, in one embodiment of the present invention, vehicle 20 no longer includes the OEM bump stops, and as shown in the embodiment in FIG. 19, the bottom surface of side rail 61R can come into contact with the top of the rear axle.

FIGS. 19-2 to 19-12 are photographic representations of various aspects of the rear suspension of vehicle 20″. FIGS. 19-2 and 19-3 are photographic representations of the rear suspension of vehicle 20″, and can be used in conjunction with the close-up photographic representations that follow to orient the reader to location and placement of components.

FIGS. 19-4 to 19-6 show modifications to and relocation of trailing arm 49. In the OEM vehicle 10, trailing arm 49 is pivotally attached to the top bracket 05.2 (as best seen in FIG. 19-5). In vehicle 20″, bracket 05.2 is not used, and instead trailing arm 49 is pivotally attached to the bottom of a bracket 57. Bracket 57 is bolted or otherwise coupled to the side rail and preferably also bolted to OEM bracket 05.2 (as best seen in FIGS. 19-5 and 19-6). Trailing arm 49 has been modified both for increased length and also to accommodate mounting of airspring 52 (as best seen in FIG. 19-11).

FIGS. 19-7 and 19-8 show the modification to an OEM jounce bumper that was on top of and above OEM tube axle 51. This OEM jounce bumper has been modified so that it no longer provides a jounce bump stop during compression of rear suspension 50 of vehicle 20″. Instead, this protection during suspension compression is provided by jounce bumper 55. FIGS. 19-9 and 19-10 show the location of a jounce bumper 55 located within the upper interior of the aft end of each frame side rail. Jounce bumper 55 contacts the top surface of tube axle 51 during maximum compression of rear suspension 50.

FIGS. 19-11 and 19-12 show end and top views, respectively of air spring 52 and its mounting bracket 53. The bottom end of air spring 52 is coupled to a circular plate attached to the top of trailing arm 49. The upper end of air spring 52 is nested within a four-sided welded bracket 53. Stabilizer bar 05.3 (FIG. 19-3) extends across from the left bracket 53 to the right bracket 53.

FIGS. 19-13 to 19-18 depict a rear suspension of a vehicle modified from the OEM configuration. These figures show the interface between a vertically-extending bracket 58.2 (such as in FIG. 19-15) and a rub block 58.1 attached to side rail 61R. As the rear suspension moves up and down, the inward face of bracket 58.2 comes into sliding contact with rub block 58.1. Since rub block 58.1 is fabricated from a smooth, ultra high molecular weight polyethylene material, relatively little noise, friction, or wear is generated by vertical relative movement of the block and the bracket face. A similar rub block is attached to the frame on the other side of the vehicle, and in a similar manner interfaces with a vertically-extending bracket attached to the tube axle. If a wheel is disturbed by the roadway such that a force is placed on it to move it outwardly relative to the vehicle, then the rub block on the other side of the chassis prevents or minimizes the lateral movement (especially because the right and left suspensions are not independent as shown in these figures, but rather are linked by the tube axle). Likewise, a force from the roadway attempting to push a wheel inward toward the frame is resisted by the bracket and rub block interface at that same wheel.

FIGS. 19-13 and 19-14 further show the leaf spring 49 that is coupled to the tube axle. In some embodiments, leaf spring 49 is a modification of the OEM spring. Preferably, the modification reduces the stiffness of the spring, such that the modified spring is unable to support that side of the vehicle without bottoming the suspension. In some embodiments, this reduction in stiffness is accomplished by removing a leaf from the spring. However, the present invention also contemplates those embodiments in which the OEM spring is replaced in its entirety with a new and weaker spring.

As best seen in FIG. 19-18, rear airbag 52 interfaces between an end of leaf spring (also trailing arm) 49 and a bracket 53 extending laterally outward from the frame rail. Preferably, airspring 52 is located aft of the tube axle, although the other embodiments of the present invention are not so constrained, and contemplate an air spring having one end located on the tube axle, and further those embodiments in which the leaf spring is forward of the tube axle. FIGS. 19-15 and 19-1 show an extension limiter 48 coupled at one end to the frame side rail and at the other end to the trailing arm 49. Extension limiter 48 is flexible, but is resistant to being stretched beyond a predetermined length. Extension limiter 48 thus limits the relative displacement between a wheel suspension and the vehicle frame.

FIGS. 19-15 to 19-17 provide a comparison of bracket 58.2 and rub block 58.1. In FIG. 19-15, the suspension is low relative to the frame, and therefore only the top portion of bracket 58.2 is in sliding contact with rub block 58.1. Referring to FIG. 19-17, the suspension has been compressed, and the middle portion of bracket 58.2 is in sliding contact with rub block 58.1, and the top of the bracket is above the top of the rub block.

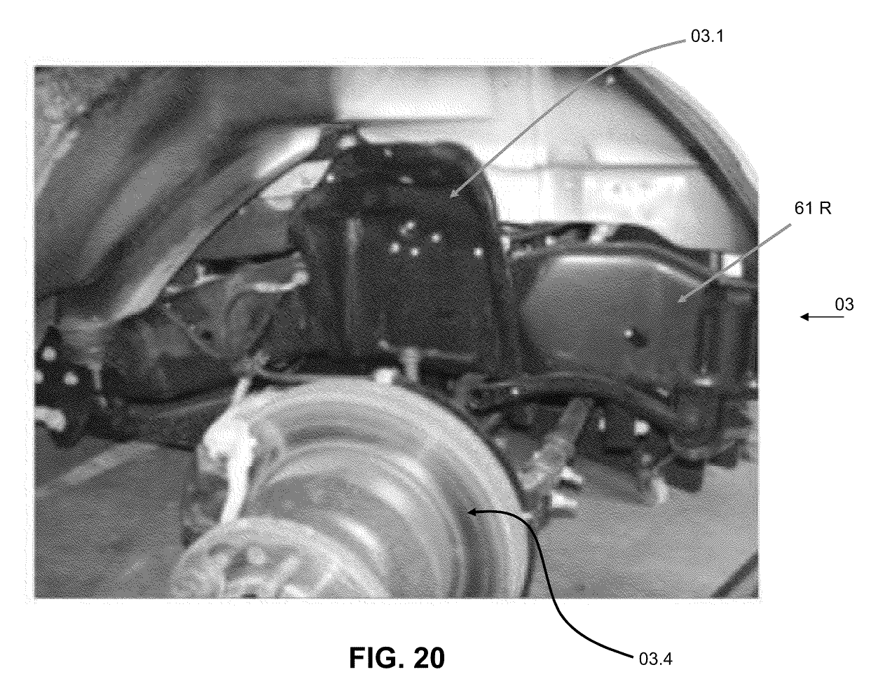

FIGS. 20, 21, 22, 23, and 24 show various aspects of the front suspension of a vehicle according to one embodiment of the present invention. FIG. 20 is a right side view looking inward of the right front suspension 03 of a vehicle 10. As shown in FIG. 20, vehicle 10 has had the coil spring and shock absorbers removed, leaving an empty spring housing 03.1. Brake disk 03.4 can be seen in the foreground.

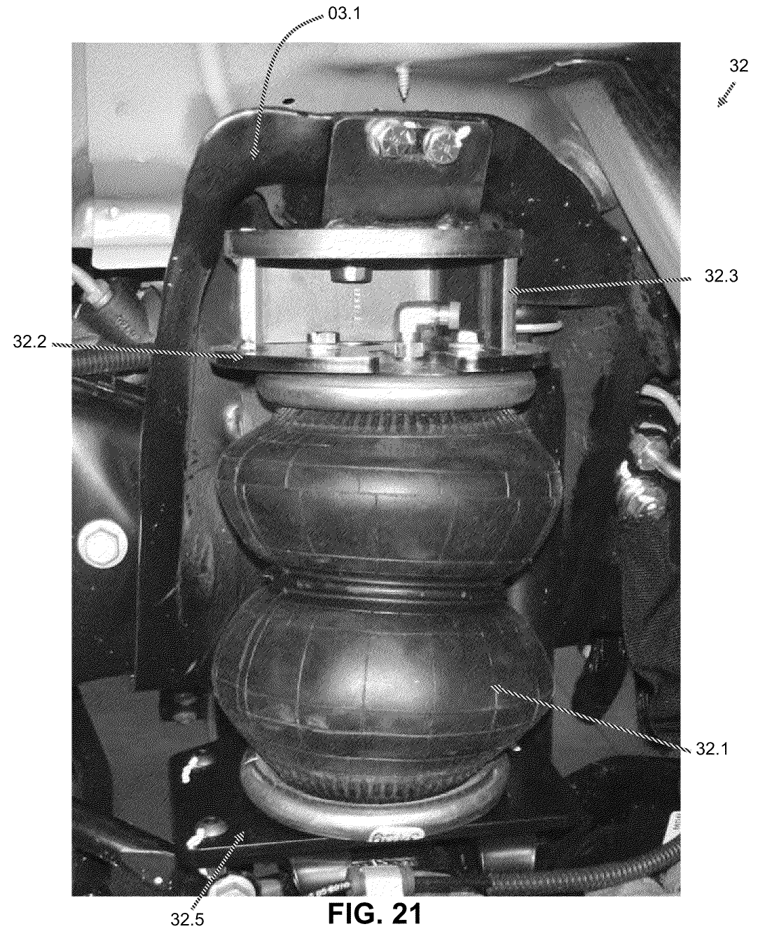

FIG. 21 shows an air spring assembly 32 according to one embodiment of the present invention. Spring assembly 32 includes an air spring 32.1 attached at its bottom to an attachment plate 32.5 and at the top to a top attachment plate 32.2. Top plate 32.2 further includes a tower section 32.3 that is adapted and configured to fasten to the OEM fastening pattern within spring well 03.1. In some embodiments, tower 32.3 provides a protected volume for air lines and fittings between the air system (not shown) and air spring 32.1.

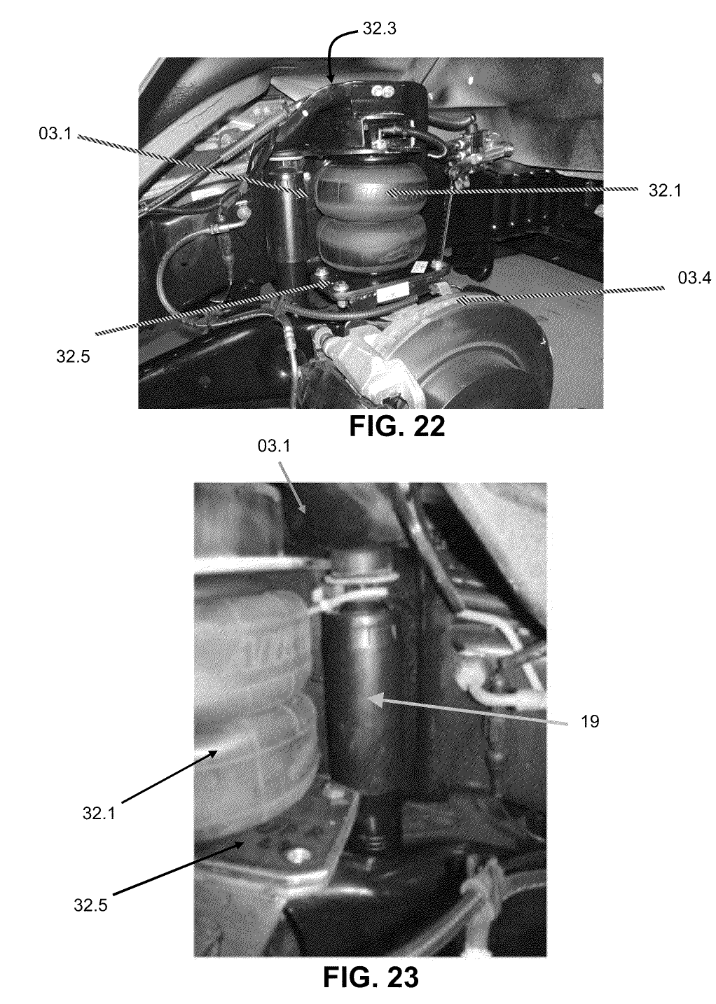

FIGS. 22 and 23 show the air spring assembly 32 installed within the OEM front suspension 03 of a vehicle 20. Referring to FIG. 22, it can be seen that the top of tower 32.3 is fastened to the underside of spring well 03.1. Referring to FIG. 23, the OEM shock absorber 19 has been re-installed within spring well 03.1, although other embodiments of the present invention contemplate a vehicle 20 including a replacement shock absorber.

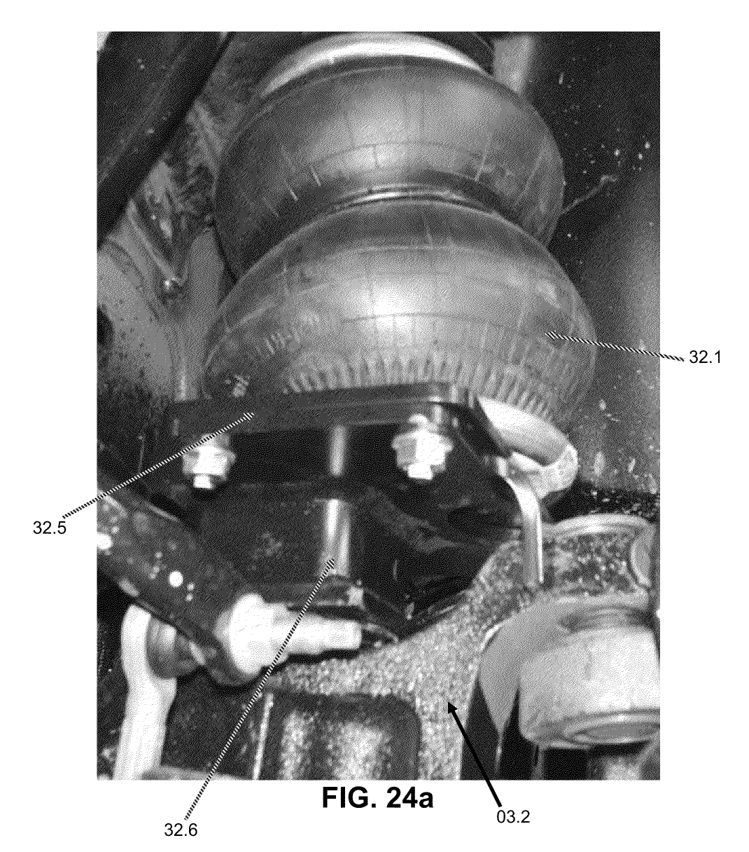

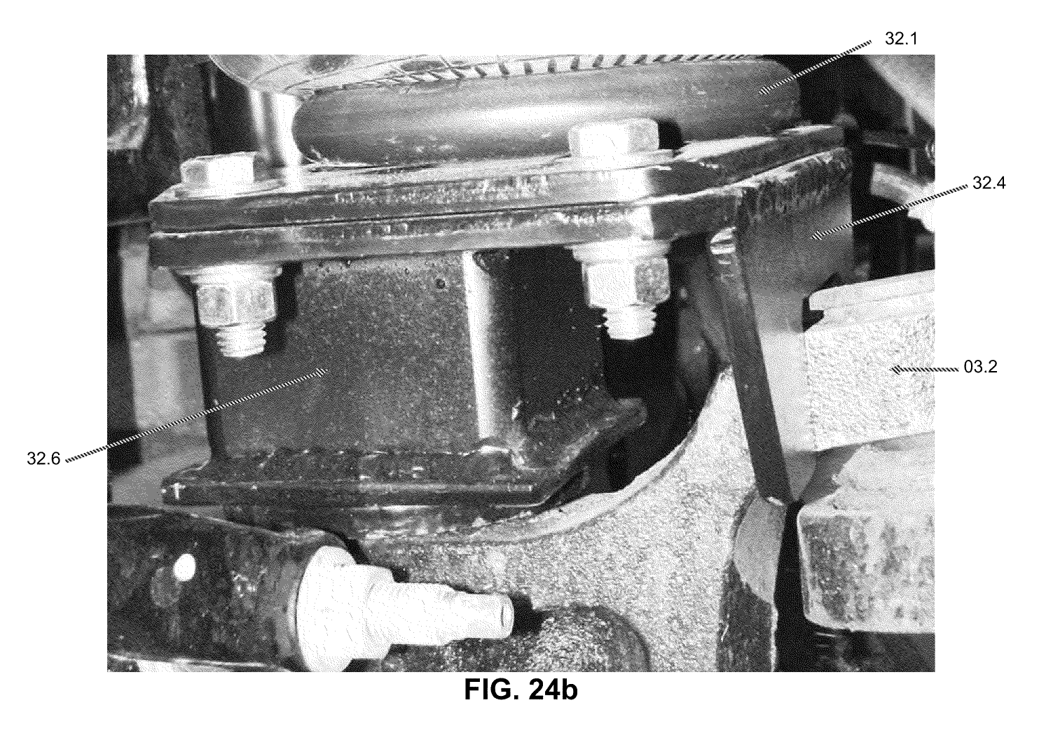

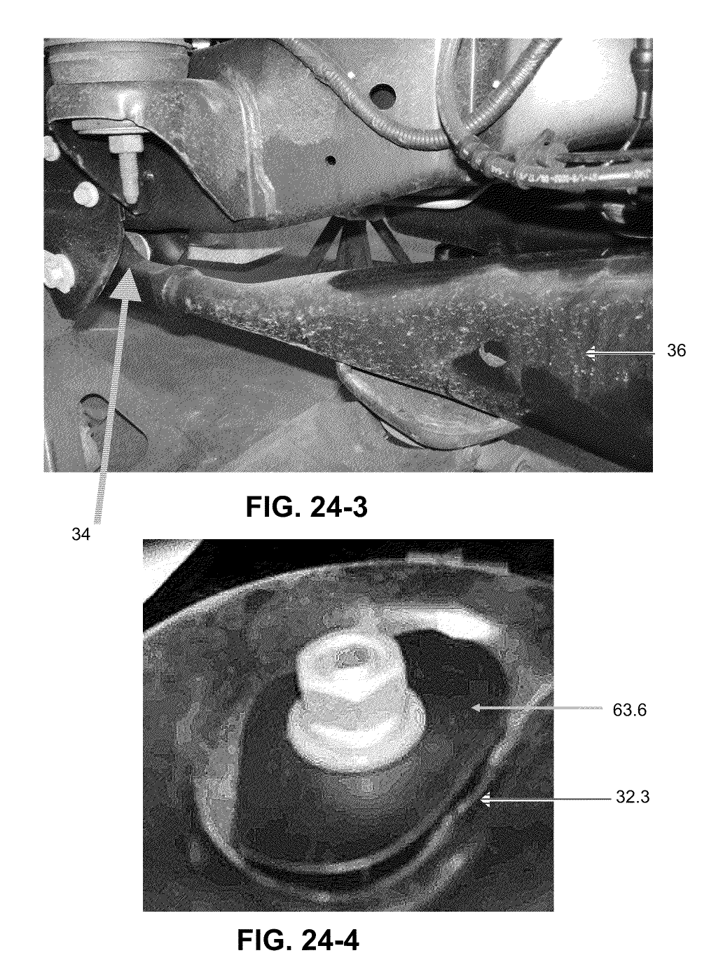

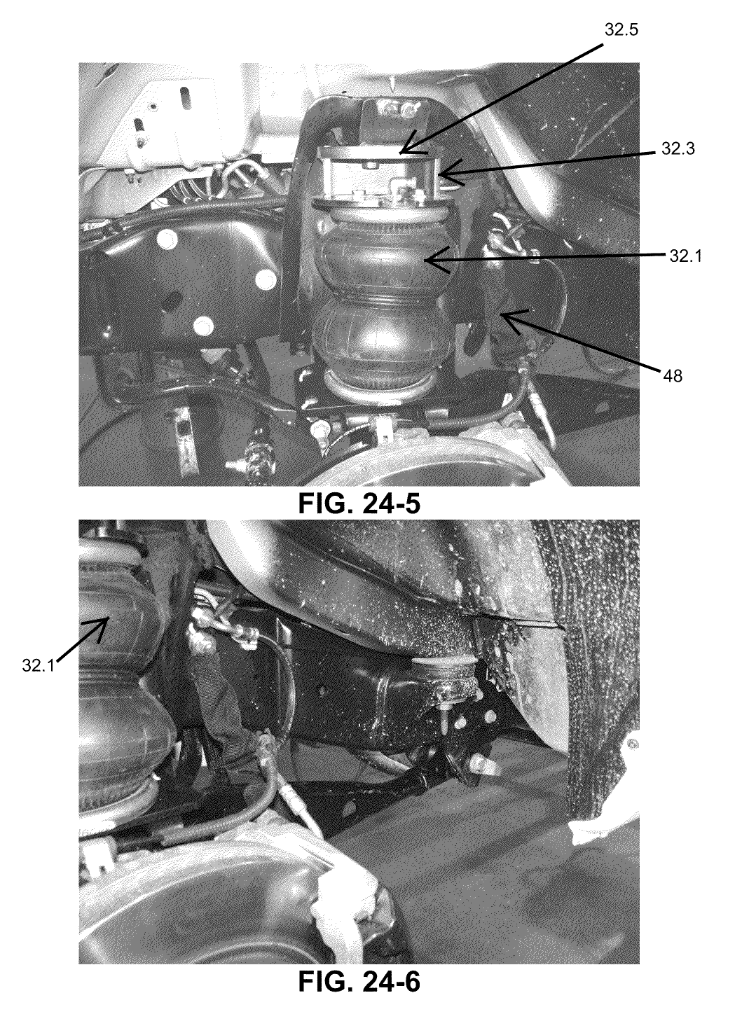

FIGS. 24a and 24b show the bottom connection of air spring assembly 32 to the front suspension 03. Referring to FIG. 24a A, bottom plate 32.5 is attached to a stand off attachment section 32.6. The former is fastened to air spring 32.1, whereas the latter is fastened to front knuckle 03.2 (knuckle 03.2 being pivotal about pivot axis 03.25). FIG. 24a also shows how the centerline of the air spring is laterally displaced from the attachment of standoff 32.6 to knuckle 03.2.

Because of this offset between the centerline of air spring 32.1 and the attachment to knuckle 03.2, in some embodiments of the present invention there is a lateral stabilizing plate 32.4 that extends downward from plate 32.5. As best seen in FIG. 24b, this stabilizing plate 32.4 includes a central notch that receives within it the upper attachment of knuckle 03.2 that extends to pivot axis 03.25. Stabilizing plate 32.4 helps maintain the fore and aft position of air spring 32.1 during operation of the front suspension.

FIGS. 24-3 to 24-6 show different aspects of the front suspension of vehicle 20″. FIG. 24-3 shows a modified pivot bushing at the front of trailing arm 36 that allows increased pivoting of trailing arm 36. FIG. 24-4 shows a reinforcing doubler 63.6 placed loosely between the top of front suspension tower 32.3 and the head of a fastener.

FIGS. 24-5 and 24-6 also show a flexible extension limiter 48 coupled at one end to the side rail and at the other end to the suspension arm. Extension limiter 48 is adapted and configured to limit the maximum rebound movement (or separation) of the chassis from the suspension arm. A similar suspension limiter 48 is shown for the rear suspension also.

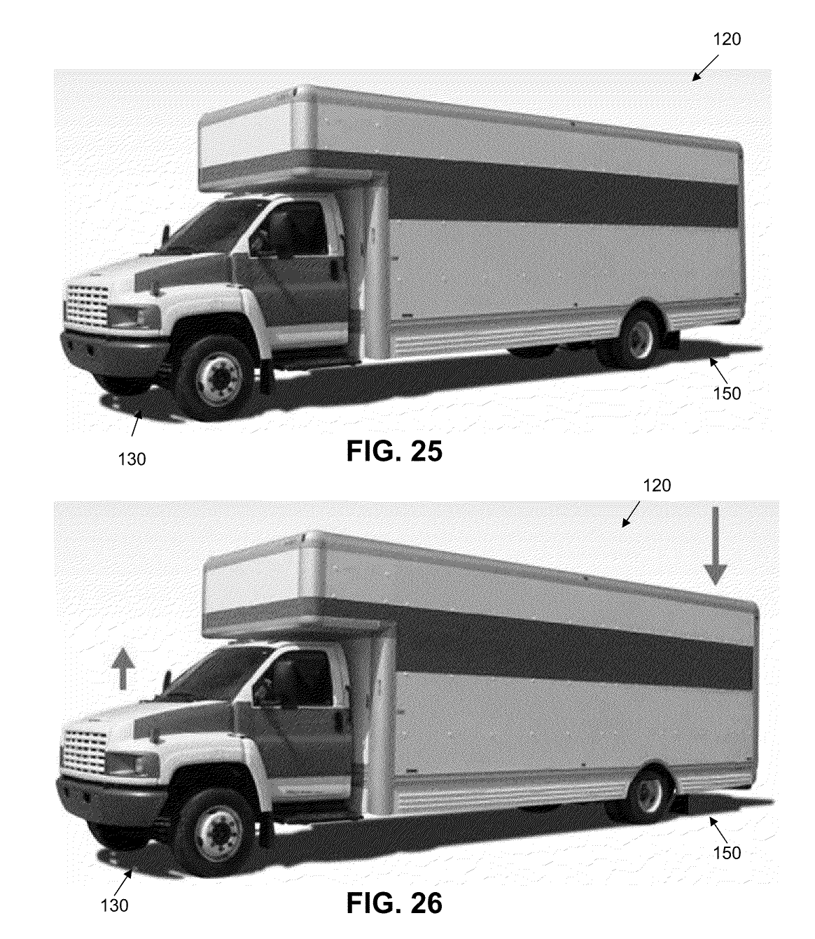

FIG. 25-28 are perspective photographic representations of a vehicle according to another embodiment of the present invention. Vehicle 130 includes air springs for both front suspension 130 and rear suspension 150. Vehicle 120 further includes a pneumatic system 190 for automatic control, safety lockouts, and manual control of the pressure within the various air springs. In one embodiment, the pneumatic system includes control valve of the type such as Viking Extreme© air control valve sold by Parker Hannifin Corp.

FIG. 25 shows a vehicle 120 with front and rear airbags 132.1 and 152, respectively, inflated to maintain internal floor 122 at a level, standard height for transport of people or equipment. In this configuration vehicle 120 is suitable for being driven normally on roadways.

FIG. 26 shows a configuration in which rear air springs 152 have been deflated. In so doing, the rear of vehicle 120 lowers. Because of the interconnection of the front and rear suspension by the frame, and the rearward shift in the center of gravity of the vehicle because of the deflation of the rear air springs, the front of vehicle 120 rises upward a first amount. FIG. 26 shows vehicle 120 in a loading position. Pressure in rear air springs 152 was released (either totally or partially) by manual actuation of a pneumatic valve placed near the rear of the cargo compartment of vehicle 120 in some embodiments, and by actions of the electronic controller in other embodiments. This release of air pressure can only be effectuated under safe conditions, such as by placing the transmission in park, placing the ignition switch in a non-engine running state, a general, straight-ahead steering alignment of the front wheels, and/or actuation of the parking brake. In addition, the cab 110.4 can also include a pneumatic valve for actuation of rear air springs 152.

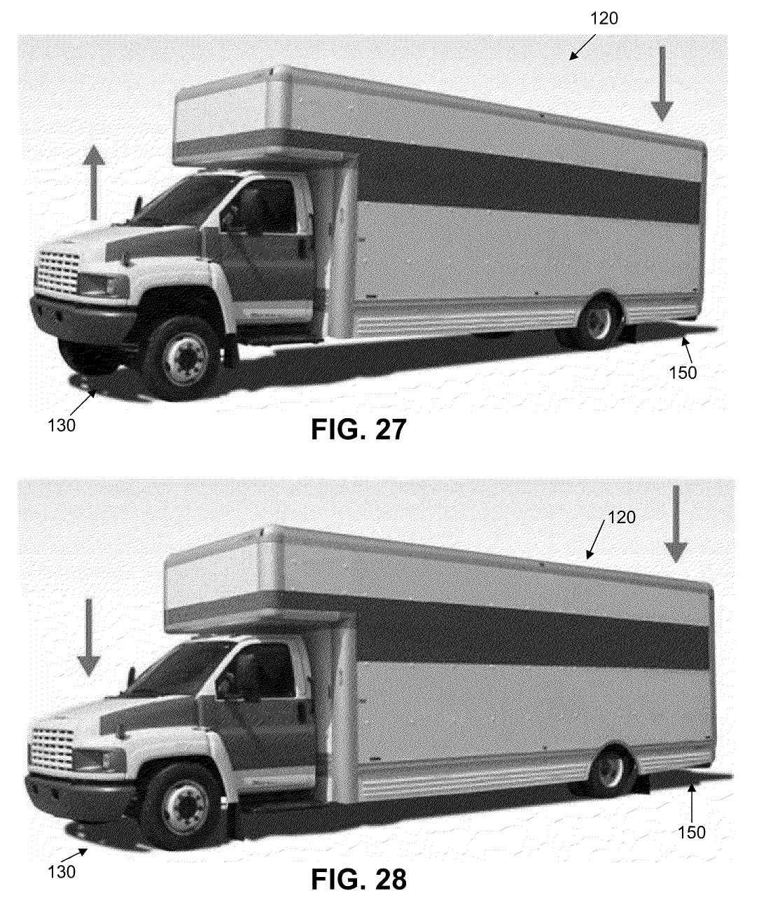

FIG. 27 shows vehicle 120 in a second loading configuration in which pressure has been added to front air springs 132.1, and pressure has been released from rear air springs 152. The increase in pressure of the front air springs raises the height of the front end, which further contributes to a rearward-shift in the center of gravity. In this configuration the rear entrance of the cargo compartment is lower than in the configuration shown in FIG. 26. Further, the angle of inclination of the internal floor 122 of vehicle 120 is greater. The configuration shown in FIG. 27 (with the rear suspension “kneeling” and the front suspension “assisting”) could be used, as one example, when loading and unloading relatively light cargo directly onto the street level.

FIG. 28 shows vehicle 120 in yet a third loading condition. Air pressure has been released (either totally or partially) in both front and rear air springs 132.1 and 152, respectively. The internal floor 122 of the cargo compartment is substantially level. Vehicle 120 can be placed in this configuration by manual control valves placed in the rear cargo area or the cabin. Alternatively, the vehicle can include an electronic controller and an electropneumatic actuation system. One or more safety interlocks prevent vehicle 120 from being driven in this fully kneeled configuration. As examples, any of the following actions could result in the vehicle automatically moving from any of the three loading conditions to the transport state of FIG. 26: taking the transmission out of park; releasing the parking brake; moving the ignition key to an engine-running state; movement of the steering wheel; or moving the steering angle of the front wheels outside of an angular deviation from the straight-ahead position.

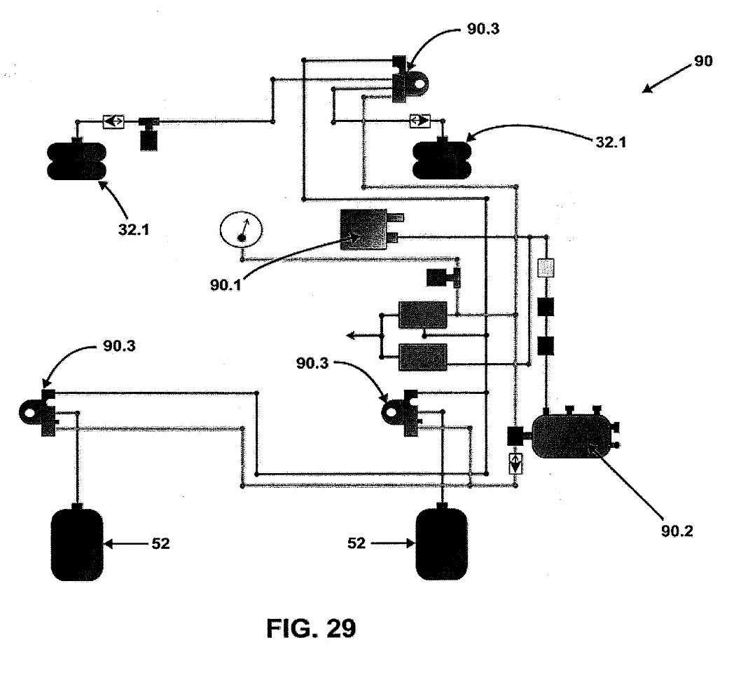

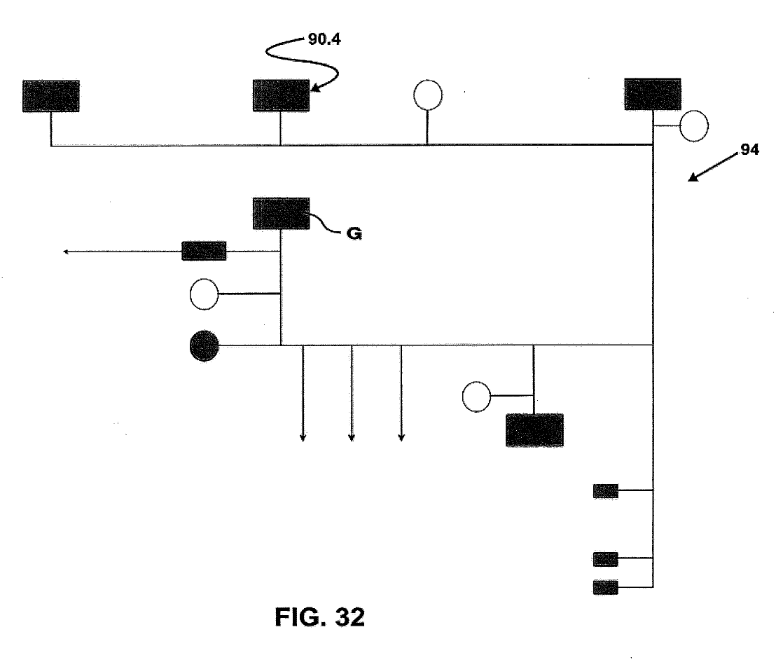

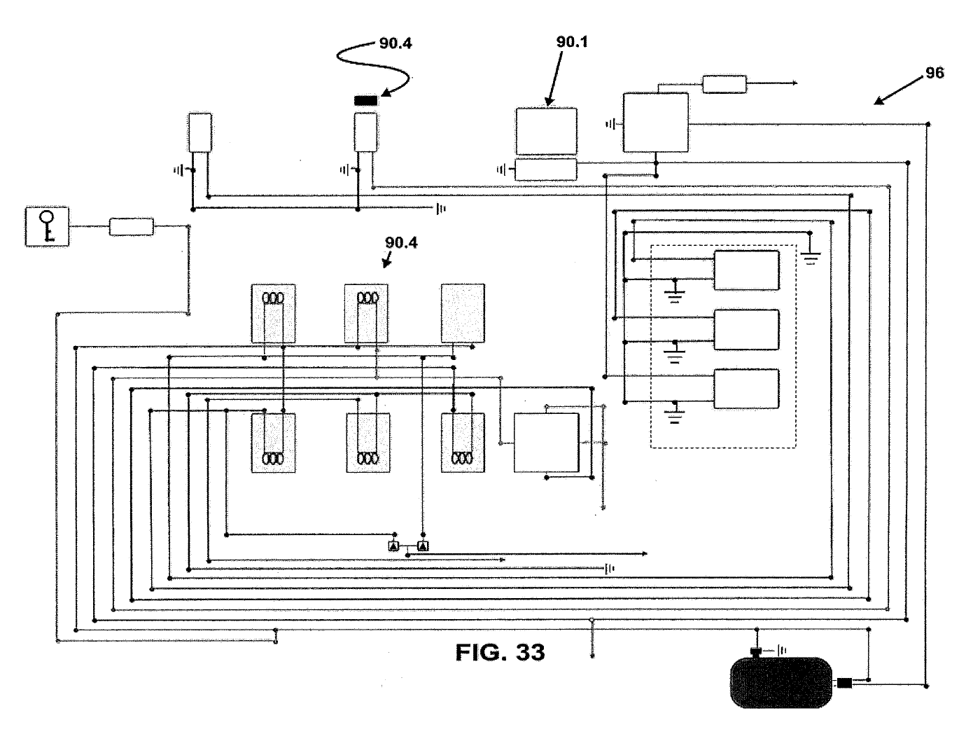

Yet another embodiment of the present invention pertains to methods and apparatus for safety interlocking of the vehicle height. Various schematic representations of the interlocked systems and electropneumatic control systems according to various embodiments of the present invention are shown in FIG. 29-33. In one embodiment, the systems shown in FIG. 29-33 each represent different aspects of the same electropneumatic control and safety interlock system. Some embodiments of the present invention include an electropneumatic control and safety interlock system as described on substantially all of FIG. 29-33. However, it is understood that other embodiments include less than all of the features and aspects of the systems depicted in FIG. 29-33.

FIG. 29 shows a pneumatic schematic diagram of an electropneumatic control and safety interlock system 90 according to one embodiment of the present invention. An engine driven compressor 91.1 (or alternatively, compressors driven by electric or hydraulic motors) provides pressurized air to a reservoir 90.2 through a check valve and one or more filters. In one embodiment, system 90 includes a plurality of mechanical and electrical switches and related devices instead of an electronic controller (such as a computer). Compressed air from tank 90.2 is provided to a plurality of control valves 90.3. Each control valve 90.3 is preferably located proximate to the suspension airbags that it controls (for example, such as within the wheel wells). Each valve is operably connected to a height control linkage that moves the valve to pressurize or depressurize an airbag in order to maintain a level height of the vehicle. In one embodiment, a single valve 90.3 controls the pressure in both of the front airbags 32.1, a single valve being sufficient because of the generally constant nature of the left to right weight distribution at the front of the vehicle. However, at the rear of the vehicle each rear airbag 52 has its own height control valve (also operably connected to a height control linkage arm). Since the right to left weight distribution at the rear of the vehicle can change as cargo or passengers are loaded or unloaded, the right and left rear bags are pressurized and depressurized independently with regards to maintaining a level height.

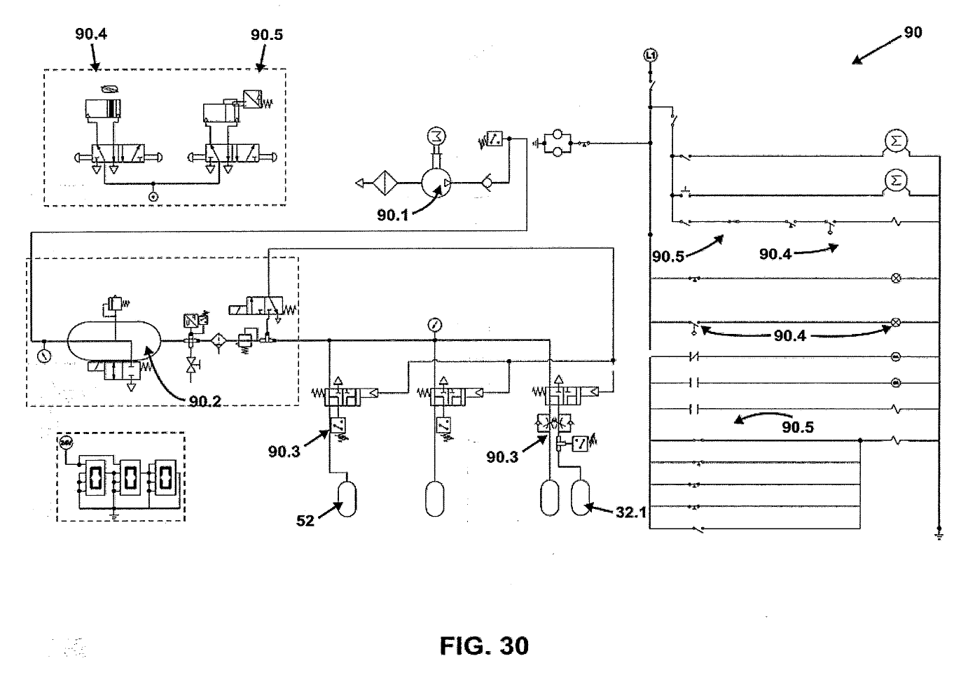

FIG. 30 is a schematic representation of a system 90 using symbology generally consistent with the standard ISO1219, and further as recognizable by those of ordinary skill in the art. FIG. 30 includes a more detailed description of system 90, including various solenoid valves, switches, gages, and other devices not shown on FIG. 29.

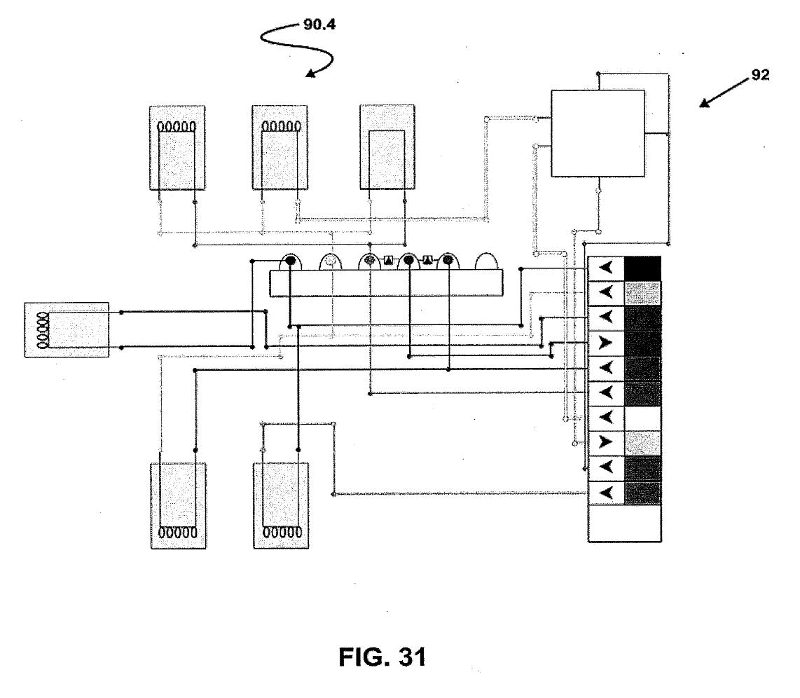

FIG. 30 depicts a portion of the interlock system 90.4 that limits the operation of system 90 based on the steering alignment of the front wheels. Also shown is a portion of interlock 90.5 that limits operation of system 90 based on whether or not a door (such as the side door) is open. Various other aspects of interlocks 90.4 and 90.5 are also shown in FIGS. 31, 32, and 33. Further, the right side of FIG. 30 shows a plurality of other switches, solenoids, and indicator lights pertaining to various safety interlocking features of system 90.

Inventive vehicles 20 and 120 described herein include rear airsprings whose internal air pressure is controlled by a pneumatic control system 90 or 190. Further, some versions of vehicles 20 and 120 include front airsprings whose internal air pressure is controlled by the same pneumatic control system. Preferably, pneumatic control system 90 and 190 include a motor-driven air pump, a plurality of solenoid actuated on/off valves, and a pressure transducer, all of which are in electrical communication with an electronic controller (which can be a separate controller, or a controller integrated into the vehicle's engine computer or chassis computer). In some embodiments, pneumatic system 90 further includes one or more manually operated valves that can dump pressure within an airspring to ambient conditions. Further, some systems 90 further include an accumulator or reservoir for containing a quantity of pressurized air. Various embodiments contemplate air pumps driven by an electrical motor (such as a twelve volt motor) and also those driven by the engine (such as an engine accessory driven by a V-belt).

As discussed above with regards to vehicle 120, some embodiments of the present invention include multiple loading orientations of the vehicle based on internal pressures within the rear and/or front airsprings (such as the partially inclined, fully inclined, and fully kneeled orientations discussed with reference to FIGS. 26, 27, and 28).

In one embodiment, placement of the vehicle in one of the loading configurations (or any orientation other than normal ride height) is enabled by proper operation of the parking brake, transmission and/or vehicle ignition system. In one embodiment, the ignition system must be placed in the auxiliary setting. In many vehicles, the auxiliary setting can only be achieved if the vehicle is placed in park. With the key in the auxiliary position, electrical power is provided to pneumatic system 90 or 190.

Actuation of the parking brake, in some embodiments, commands the pneumatic system to a particular loading configuration. In one example, actuation of the parking brake (combined with placement of the ignition key in the auxiliary position) results in a command from the electronic controller to release air pressure in all airsprings and place the vehicle in the fully kneeled position. Further, in some embodiments the release of air pressure in any air spring results in an audible warning to persons standing around a vehicle, such as a beeping of a buzzer or bell, or honking of the horn.

In yet other embodiments, in place of an electronic controller, the ignition auxiliary switch and the parking brake can directly operate dump solenoids for each of the airsprings (or alternatively, only to the rear airsprings) by an arrangement of relays and switches. In such vehicles, the vehicle changes to a loading orientation automatically with actuation of the parking brake and placement of the ignition switch in the auxiliary position. In these embodiments, taking the parking brake out of actuation automatically returns the vehicle to a predetermined ride height.

In yet other embodiments, a vehicle that is in any type of loading configuration (or alternatively, in any non-riding configuration) is automatically returned to a normal or predetermined ride height when the parking brake is released. Preferably, the ignition switch should also be in the auxiliary position. Thus, a vehicle in the partially inclined position would return to a normal ride height by operation of the pneumatic system to add air pressure to the rear airsprings. In yet another embodiment, release of the parking brake for a vehicle in the fully inclined position (refer to FIG. 27) returns the vehicle to a normal or predetermined ride height by addition of air to the rear airsprings and release of air from the front airsprings. In yet other embodiments, a vehicle in the fully kneeled position (such as in FIG. 28) is returned to a normal or predetermined ride height upon release of the parking brake by addition of air to the front and rear airsprings.

The aforementioned placement of the vehicle in a loading configuration can be to a loading configuration based on the position of one or more manual valves. For example, the user of the vehicle can set a front-mounted manual pneumatic valve to the raised position (consistent with operation according to FIG. 27) and place a rear-mounted manual pneumatic valve to the rear position. The placement of the manual valves to a predetermined position would have no effect on the orientation of the vehicle until the parking brake is actuated and, in some embodiments, placement of the ignition key in the auxiliary position. The pneumatic system thus described thereby includes electrically actuated solenoid valves that can isolate the manual pneumatic valves from fluid communication with a respective pair of airsprings.

Yet another embodiment of the present invention pertains to interlocking of the pneumatic control system with the steering system of vehicle 20 or 120. Yet another safety interlock on the operation of the pneumatic control system (and thereby on the pressure within the airsprings) includes the steering system of the vehicle. In one embodiment, the vehicle includes a potentiometer, encoder, Hall-effect sensor, or other sensor that provides a signal corresponding to the angle of the front wheels. As another example, the sensor can be positional limit switches. The signal from this steering angle sensor (or switches) is provided to the electronic controller of the pneumatic system. If the angle of the front wheels exceeds a predetermined angle off a straight-ahead orientation, then the electronic controller will not permit the vehicle to move into a loading orientation. In some embodiments, the steering angle safety interlock overrides the parking brake overlock such that the vehicle will not enter a loading orientation, even if the parking brake is applied, unless the front wheels are within a predetermined angular offset from the straight ahead position. For example, in one embodiment, the front wheels can be at an angle of no more than plus or minus five degrees (with zero degrees being straight ahead).

In yet other embodiments, the electropneumatic system responds to any movement of the steering wheel. For example, if a vehicle is placed in a loading position and the steering wheel is subsequently moved (even if the angular placement of the front wheels is within the acceptable limit), the electronic controller will command a change in air spring pressures to return to the normal ride height.

Yet other safety interlocks are based on the operation of a wheel chair ramp or cargo ramp. Some embodiments contemplate that the vehicle will not change from a loading or unloading position to a normal transport position if the ramp is extended.

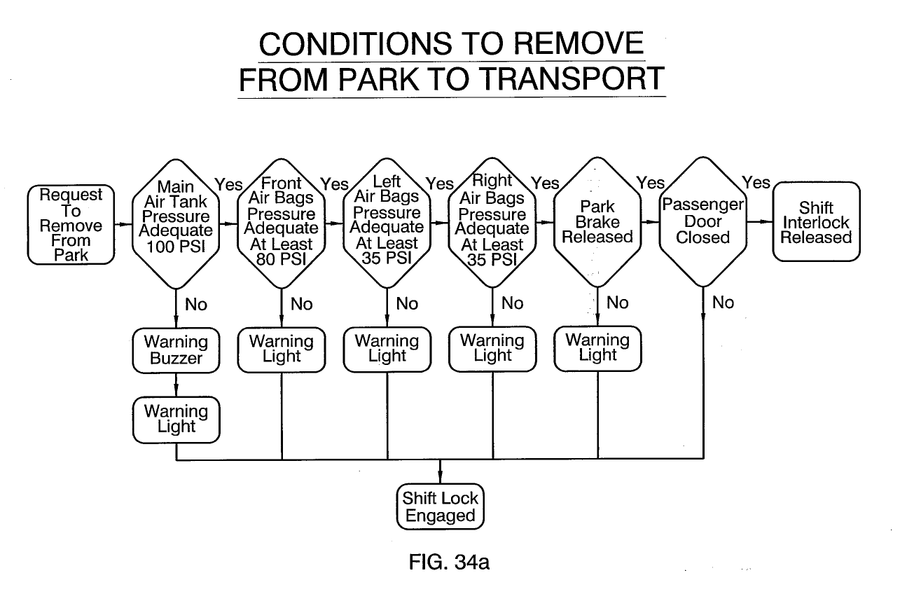

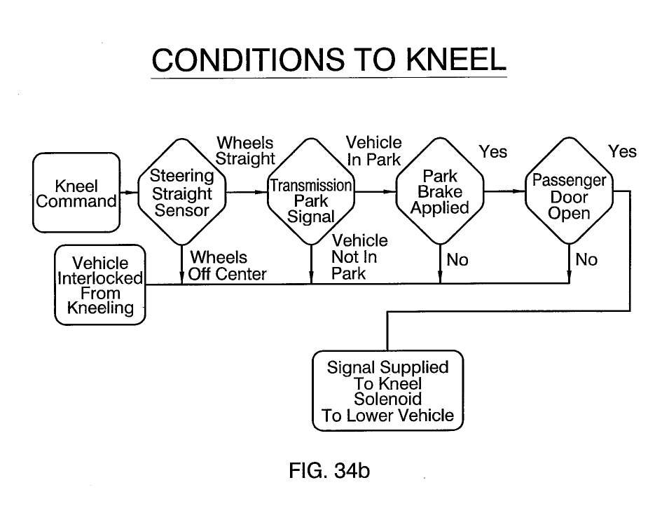

FIGS. 34a and 34b are logic flowcharts describing the interlocking operation of the gas delivery system with the controls of the vehicle according to one embodiment of the present invention. FIG. 34a shows logic from a request by the operator to remove vehicle from park, to a decision as to whether the shift interlock is released or engaged. The diagram shows a variety of logical steps (shown in diamonds) that correspond to various switches, sensors, solenoids, and other devices shown in FIG. 29-33. As the term is used herein, a switch is a particular kind of sensor, the switch being able to sense on or off conditions (also corresponding to contacting or not contacting) and can also be referred to in some situations as limit switches.

FIG. 34b shows a plurality of logical steps for determining whether or not the pneumatic delivery system will deflate one or more air springs based on the various logical steps indicated by the diamonds. Each of these logical steps correspond to a switch, sensor, relay, or other electrical device shown on any of FIG. 29-33. As can be seen, in order to kneel the vehicle, the steering angle must be generally straight, the transmission must be in park, the parking bake applied, and the passenger door opened. If all of those conditions are met, a signal will be provided to the kneel solenoid to permit exhausting of the pressurized gas from within various air springs.

Although each of FIGS. 34a and 34b show a plurality of sequential logical steps, this is shown by way of example only and should not be considered limiting. The present invention further contemplates those embodiments in which only one of the various logical steps shown in these figures is sufficient to describe the interlocking of the pressure delivery system and a vehicle control.

One embodiment of the present invention pertains to a vehicle suspension conversion system; a means to provide an increase in the total travel of a vehicle's suspension system allowing for a lower vehicle body height for entry and exit of passengers and or goods; at least two (2) of a vehicle's suspended wheels; and, wherein the converted suspended wheels are linked together by a shared operating circuit; and electrically interlocked with the vehicle's original internal electrical controls to prevent the vehicle from forward or reverse movement when the vehicle's body height is lowered to allow for entry and exit of passengers and or goods.

Another embodiment pertains to a suspension conversion that provides, at the vehicle's normal transport height, the passenger and goods entry floor to be above the rotational axis of the vehicle's wheels. Other embodiments pertain to a suspension conversion that provides, at the vehicle's lowered height, the passenger and goods entry floor to be below the rotational axis of the vehicle's wheels

Other embodiments include a suspension conversion wherein the suspension conversion utilizes, in part, air springs for the vehicle's normal jounce, rebound, and added lowering features. In some embodiments, the suspension conversion utilizes an engine driven compressor and a 12 volt independently installed air compressor.

In some embodiments, the air springs of the rear airspring suspended wheels are positioned rearward of the axle tube. In other embodiments, the air springs of the front air spring suspended wheels are positioned within the vehicle's original front suspension housing.

In some embodiments, the suspension conversion utilizes, in part, coil springs for the vehicle's normal jounce, rebound, and added lowering features. In other embodiments, the suspension conversion utilizes, in part, leaf springs for the vehicle's normal jounce, rebound, and added lowering features, and a combination of air, coil, and leaf springs within the vehicle's overall suspended wheels for the vehicle's normal jounce, rebound, and added lowering features.

In some embodiments the shared operating circuit can be electrical, pneumatic, or both, electrical and pneumatic.

In some embodiments a deployable ramp is utilized for easier entry and exit by passengers and goods, and is installed, along with its supporting housing, within the vehicle's original chassis frame. In other embodiments, the deployable ramp is located between the vehicle's front and rear wheels and is a wheelchair/disabled accessible ramp. In still other embodiments, the deployable ramp is electrically interlocked with the vehicle's original internal electrical controls to prevent the vehicle from forward or reverse movement if the ramp is in deployment.

In some embodiments, passenger and goods entry/exit doors are electrically interlocked with the vehicle's original internal electrical controls to prevent the vehicle from forward or reverse movement if the doors have not been closed and secured.

In some embodiments two of the vehicle's converted suspended wheels are the vehicle's front wheels; and the front wheel converted suspensions are linked together by a shared operating circuit that is further interlocked with the vehicle's steering system to allow the vehicle body to be lowered, only, if the front wheels are in a “straight-ahead” orientation.

In some embodiments, the shared operating circuit is electrical and the vehicle's parking brake is electrically interlocked within the shared operating circuit. In yet other embodiments, the electric sensing is done, in part, by a potentiometer or an electromagnet. The shared operating circuit can be pneumatic or both electrical and pneumatic. In some embodiments, the vehicle's original suspension's limited travel bushings are removed and replaced with elastomeric full travel bushings.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of controlling a vehicle suspension, comprising:
providing a multiwheeled vehicle having a suspension system including a plurality of pneumatic springs each in fluid communication with a source of pressurized gas;
substantially deflating at least one of the pneumatic springs while the vehicle is not moving;
attempting to drive the vehicle after said deflating; and
automatically reinflating the at least one pneumatic spring from the source by said attempting.

2. The method of claim 1 wherein said attempting is moving the transmission selector out of park.

3. The method of claim 1 wherein said attempting is turning on the engine ignition.

4. The method of claim 1 wherein said attempting is releasing the parking brake.

5. The method of claim 1 wherein said attempting is turning the steering wheel.

6. The method of claim 1 wherein the vehicle has two front wheels and two rear wheels each biased by a corresponding pneumatic spring, and said deflating is of all four pneumatic springs.

7. The method of claim 1 wherein said deflating lowers the vehicle to a loading position.

8. The method of claim 1 wherein said deflating lowers the vehicle to a ride height not recommended for normal transport.

9. The method of claim 1 wherein said deflating changes the internal gas pressure of the springs to about ambient pressure.

10. A method of controlling a vehicle suspension, comprising:
providing a multiwheeled vehicle having a suspension system including right and left front pneumatic springs and right and left rear pneumatic springs, each spring being in fluid communication with an exhaust to ambient conditions and a source of pressurized gas, the vehicle having an operator-actuated control having a plurality of positions;
attempting to substantially exhaust gas from all four pneumatic springs when the vehicle is not moving;
automatically preventing exhausting of gas during said attempting based on the position of the control.

11. The method of claim 10 wherein the operator-actuated control is the transmission selector, and said preventing is based on the selector not being in park.

12. The method of claim 10 wherein the operator-actuated control is the parking brake, and said preventing is based on the brake not being on.

13. The method of claim 10 wherein the operator-actuated control is the steering wheel, and said preventing is based on the steering angle exceeding a predetermined limit.

14. An apparatus for controlling the height of a vehicle, comprising:
a multiwheeled vehicle having at least one steerable wheel;
a source of pressurized gas;
a pneumatic spring for biasing the vehicle to a position relative to said steerable wheel;
an electrically actuatable valve in fluid communication with said source and said spring
a sensor for providing a signal corresponding to the angular orientation of the steered wheel;
an electrical circuit which receives the signal and actuates said valve based on the angle of the steered wheel.

15. The apparatus of claim 14 wherein said circuit actuates said valve to provide pressurized gas to inflate said spring when the angle exceeds a predetermined limit.

16. The apparatus of claim 14 wherein said valve is also in fluid communication with an ambient exhaust, and said circuit prevents said valve from exhausting the gas in said spring if the signal exceeds a predetermined limit.

17. The apparatus of claim 14 wherein said vehicle includes a fender over said steerable wheel, a tire is mounted to said wheel, and the predetermined limit is chosen to prevent contact between said fender and said tire.

18. The apparatus of claim 14 wherein said sensor includes a magnetic switch.

19. The apparatus of claim 14 wherein said sensor is a limit switch.

20. The apparatus of claim 14 wherein said sensor is a potentiometer.

21. The apparatus of claim 14 which further comprises an electronic controller having software, and said electrical circuit is operated by said controller.

22. An apparatus for controlling a vehicle suspension, comprising:
a multiwheeled vehicle having at least one steerable wheel;
a source of pressurized gas;
a pneumatic spring for biasing the vehicle to a position relative to said steerable wheel;
an electrically actuatable valve in fluid communication with said source and said spring;
means for interlocking the actuation of said valve based on the state of the vehicle.

23. The apparatus of claim 22 wherein said interlocking means includes a steering angle sensor and said valve is prevented from depressurizing said spring if the steering angle exceeds a predetermined limit.

24. The apparatus of claim 22 wherein said vehicle includes a deployable ramp, said interlocking means includes ramp position sensor, and said valve is prevented from pressurizing said spring if said ramp is deployed.

25. The apparatus of claim 22 wherein said interlocking means includes a transmission selection sensor, and said valve is prevented from depressurizing said spring if said selector indicates that the transmission is not in park.

26. The apparatus of claim 22 wherein said interlocking means includes a transmission selection sensor, and said valve provides fluid communication between said source and said spring if said selector indicates that the transmission moved out of park.

27. The apparatus of claim 22 wherein said interlocking means includes a parking brake switch and said valve is prevented from depressurizing said spring unless the parking brake is on.

28. The apparatus of claim 22 wherein said interlocking means includes a parking brake switch and said valve provides fluid communication between said source and said spring the parking brake is moved from on to off.

29. A method of modifying a vehicle chassis, comprising:
providing an OEM vehicle having a frame and right and left front wheels and right and left rear wheels, each wheel being biased apart from the OEM frame by a corresponding OEM spring;
replacing the right and left front springs with right and left front air springs;
reducing the stiffness of each right and left rear spring;
adding right and left rear air springs to the rear suspension; and
removing the OEM bump stops from the right and left front suspension and from the right and left rear suspension.

30. The method of claim 29 wherein the right and left front wheels are steerable, and which further comprises mounting a sensor to the vehicle that provides a signal corresponding to movement of the vehicle steering system.

31. The method of claim 29 which further comprises adding a system for delivery of compressed gas to each air spring and means for interlocking the operation of the system with the vehicle controls.

32. The method of claim 31 wherein the means for interlocking is based on steering angle.

33. The method of claim 29 which further comprises adding a bracket to each of the right and left rear suspensions, adding an organic material rub block one each of the right and left sides of the frame, wherein vertical motion of a side of the rear suspension results in sliding motion between the rub block of that side and the bracket of that side.

34. The method of claim 29 which further comprises removing OEM spacers from the top of the OEM frame.

35. The method of claim 29 wherein the front OEM springs are coil springs.

36. A method of modifying a vehicle chassis, comprising:
providing an OEM vehicle having an OEM frame with right and left longitudinally extending side rails, the OEM vehicle having an OEM ride height during normal operation of the vehicle;
modifying the left side rail to accommodate a deployable ramp;
adding an ADA-compatible deployable ramp to the vehicle;
operating the modified chassis at the OEM ride height.

37. The method of claim 36 wherein said modifying is by notching the left side rail.

38. The method of claim 36 wherein the ramp is deployable by unfolding.

39. The method of claim 36 wherein the ramp is deployable by lateral extension.

40. The method of claim 36 wherein the ramp is a wheelchair ramp that does not translate vertically.

41. The method of claim 36 which further comprises replacing the front suspension OEM springs with airsprings.

42. The method of claim 36 which further comprises adding an air spring to each side of the rear suspension.
